(19) United States
(12) Patent Application Publication
(10) Pub. No.: US 2026/0003635 A1
(43) Pub. Date: Jan. 1, 2026

(54) SYSTEM, METHOD, AND PROGRAM PRODUCT FOR HIGH DIMENSIONAL COMPUTING

(71) Applicant: Hsilin Huang, Cupertino, CA (US)

(72) Inventor: Hsilin Huang, Cupertino, CA (US)

(21) Appl. No.: 18/949,353

(22) Filed: Nov. 15, 2024

Related U.S. Application Data
(60) Provisional application No. 63/666,242, filed on Jul. 1, 2024.

(51) Int. Cl. G06F 9/38; G06F 7/485; G06F 7/487

(52) U.S. Cl. CPC G06F 9/3895; G06F 7/485; G06F 7/4876; G06F 9/3867

(57) ABSTRACT

A system, method and computer product for processing tensor data comprising the steps of: receiving weight tensor data from a memory bank; storing the weight tensor data in a weight tensor buffer; receiving feature map data from the memory bank; storing the feature map data in an FVC buffer; broadcasting a portion of the weight tensor data; receiving and processing the portion of weight tensor data with one or more computing units; transferring a portion of the feature map data to the one or more computing units; receiving and processing the portion of feature map data in the one or more computing units; performing elementwise multiplication operation of the weight tensor data and feature map data; summing a result of the elementwise multiplication operation of the weight tensor data and feature map data; and storing a result of the summation in an accumulator.

### CROSS-REFERENCE TO RELATED APPLICATIONS

The present Utility patent application claims priority benefit of the [U.S. provisional application for patent Ser. No. 63/666,242 filed on 30 Jun. 2024 under 35 U.S.C. 119 (e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to high-dimensional computing architectures. More particularly, certain embodiments of the invention relate to processing units tailored for seamless manipulation of 4-dimensional tensors in high-performance computing environments.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that traditional Central Processing Units (CPUs) typically operate with a limited number of threads, each handling a single piece of data or a few data elements. Graphics Processing Units (GPUs) leverage a Single Instruction, Multiple Data (SIMD) architecture with multiple threads, where each thread is associated with a fixed number of data elements, typically 32 or 64. In the current landscape of computing, Central Processing Units (CPUs), Graphics Processing Units (GPUs), and Neural Processing Units (NPUs) may play pivotal roles in handling a diverse range of computational tasks. As the demand for processing multi-dimensional data, particularly 4-dimensional or more than 4-dimensional tensors, continues to grow, these conventional units may face challenges in achieving optimal efficiency.

Similarly, typical GPUs, renowned for their parallel processing capabilities through SIMD architectures, may confront hurdles when it comes to processing multi-dimensional data. Achieving efficient parallelization for 4-dimensional tensors may require intricate programming and may often involve nested loops, leading to a suboptimal use of the GPU's potential. This not only complicates the programming process but may result in power wastage without effective data reuse.

Typical Neural Processing Units (NPUs), while specialized for neural network computations, may predominantly cater to vector data. When extended to handle 4-dimensional tensors, NPUs may encounter challenges in optimizing the manipulation of such structures efficiently. The traditional approach of using multiple loops for tensor operations not only strains computational resources but may hamper the unit's ability to deliver the desired performance in neural network layers like Convolutional Layers, Linear Layers, and Matrix Multiplication Layers.

Recognizing the limitations of existing paradigms, there is a need for a processing unit that not only extends the SIMD concept to multiple dimensions but also incorporates advanced Data Flow Computing techniques and enhances computational efficiency by reducing SIMD to a Single Instruction per data layer.

In view of the foregoing, it is clear that these traditional techniques are not perfect and leave room for more optimal approaches.

### BRIEF DESCRIPTION OF THE DRA WINGS

The present invention is illustrated by way of example, and not by way of limitation, in the figures of the accompanying drawings and in which like reference numerals refer to similar elements and in which:

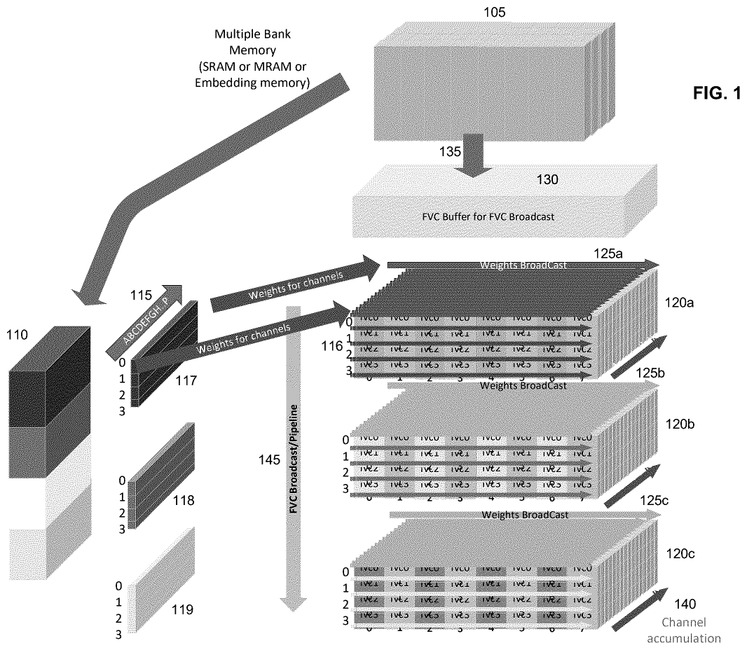

FIG. 1 is an illustration of an exemplary Multiple Dimensional computing architecture for AI computing, in accordance with an embodiment of the present invention;

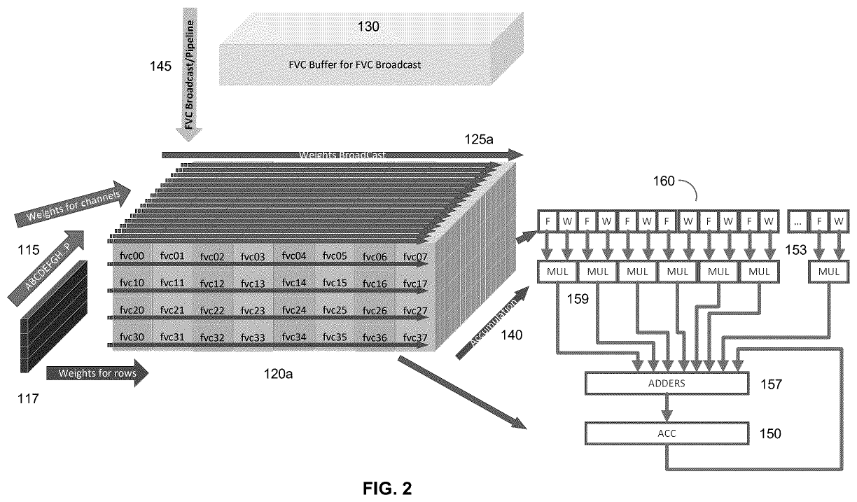

FIG. 2 is an illustration of an exemplary broadcast of weights of different input and output channels through multiple-dimensional computing cells, in accordance with an embodiment of the present invention;

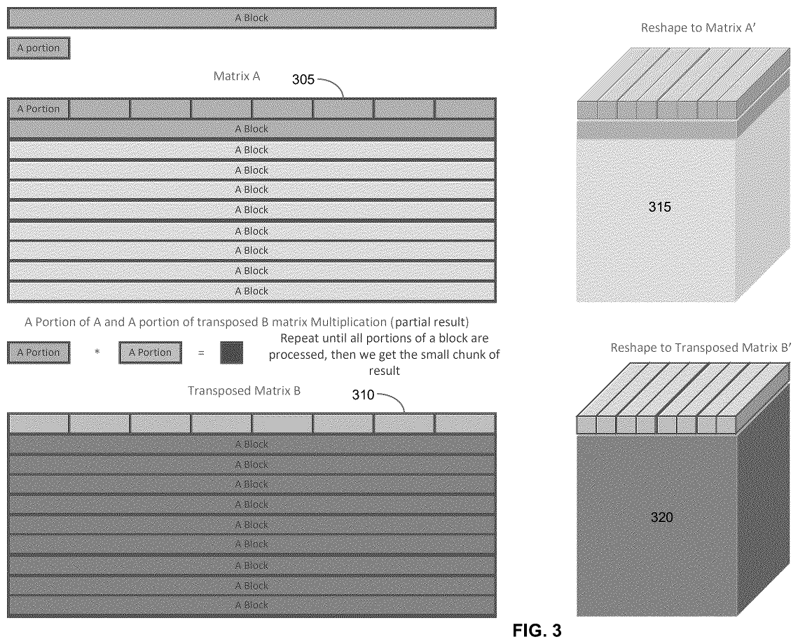

FIG. 3 is an illustration of exemplary matrices for distributing weight and feature map data in a high dimensional architecture, in accordance with an embodiment of the present invention;

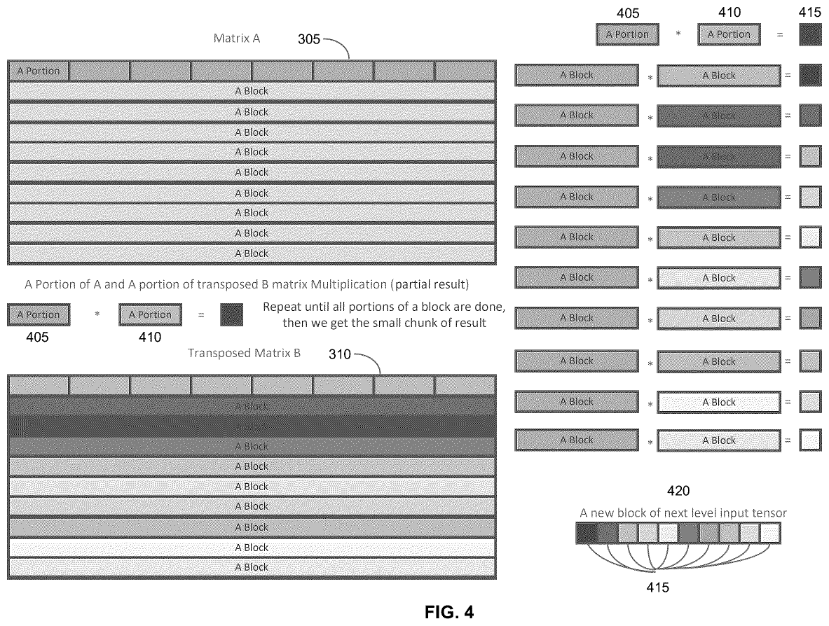

FIG. 4 is an illustration of an exemplary matrix multiplication, in accordance with an embodiment of the present invention;

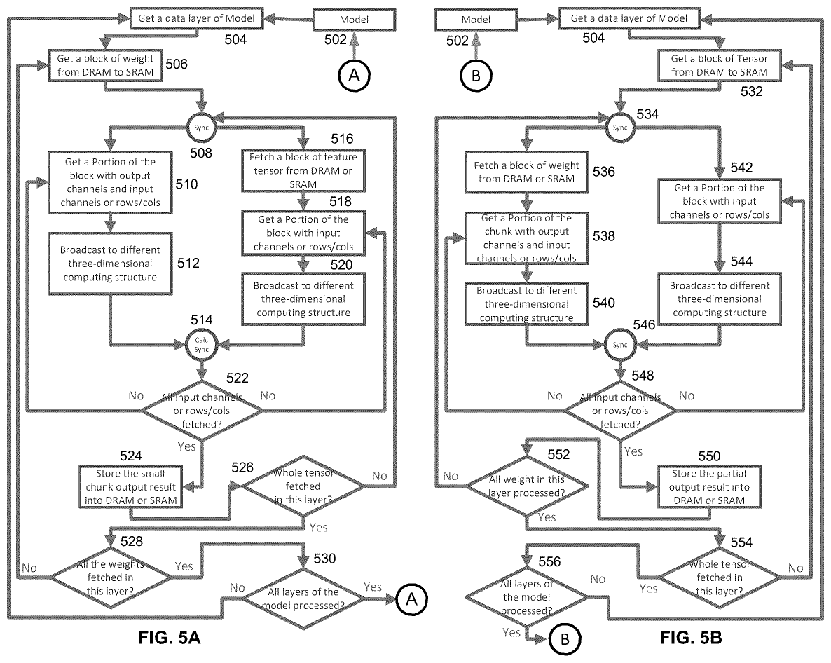

FIG. 5A is an illustration of an exemplary flowchart of a weight stagnation and FIG. 5B is an illustration of an exemplary flowchart of a feature map stagnation, in accordance with an embodiment of the present invention;

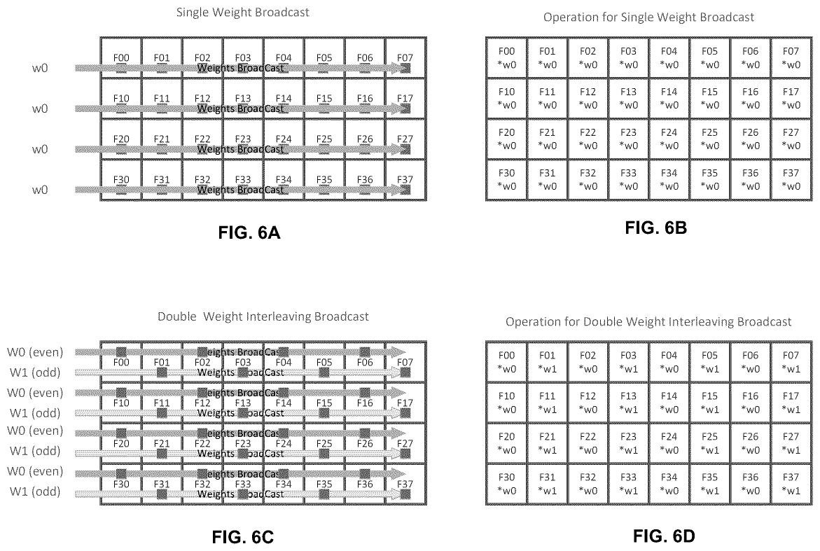

FIG. 6A is an illustration of an exemplary “Single Weight Broadcast”, FIG. 6B is an illustration of an exemplary elementwise vector multiplication, FIG. 6C is an illustration of an exemplary “Double Weight Interleaving Broadcast”, and FIG. 6D is an illustration of an exemplary elementwise vector multiplication, in accordance with an embodiment of the present invention;

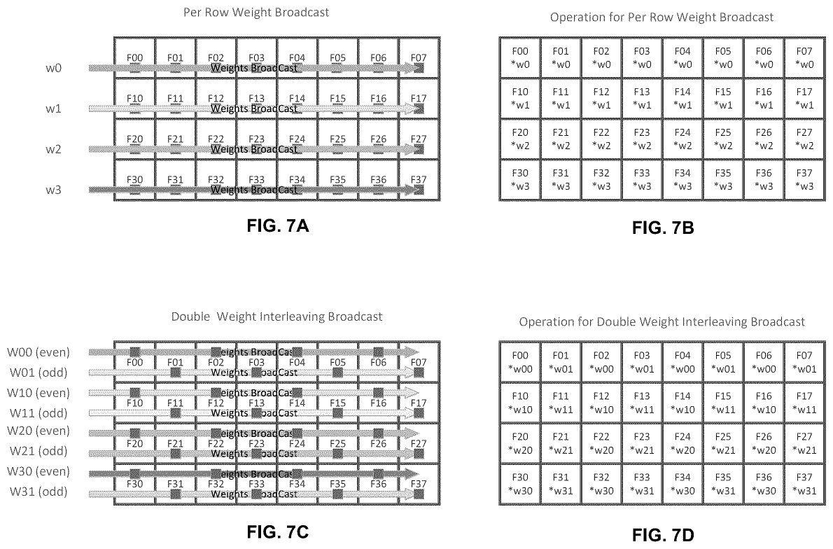

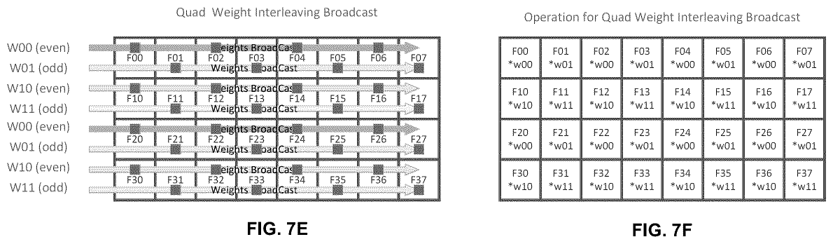

FIG. 7A is an illustration of an exemplary “Per Row Weight Broadcast”, FIG. 7B is an illustration of an exemplary elementwise vector multiplication for Per Row Weight Broadcast, FIG. 7C is an illustration of an exemplary “Double Weight Interleaving Broadcast”, FIG. 7D is an illustration of an exemplary elementwise vector multiplication for Double Weight Interleaving Broadcast, FIG. 7E is an illustration of an exemplary “Quad Weight Broadcast”, FIG. 7F is an illustration of an exemplary elementwise vector multiplication for Quad Weight Broadcast, in accordance with an embodiment of the present invention;

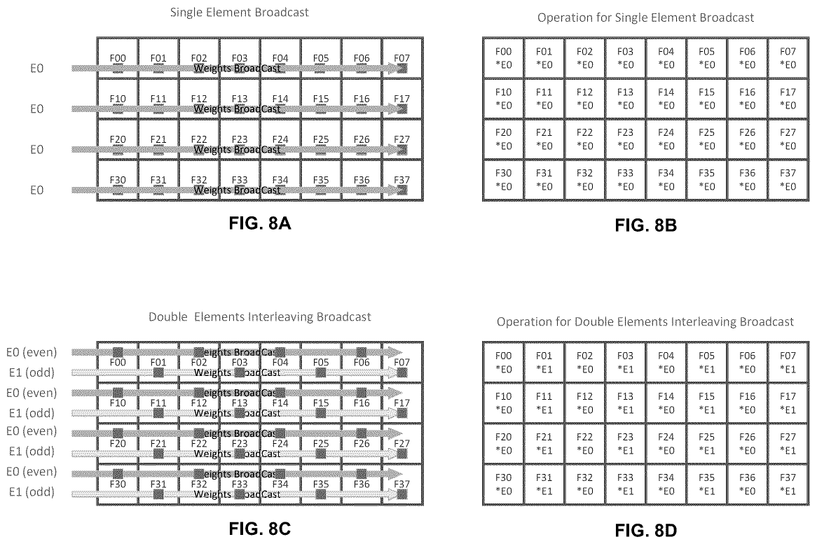

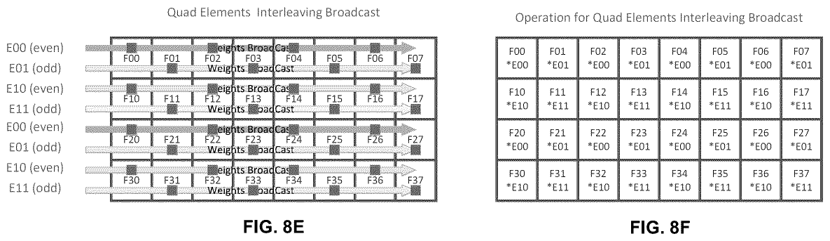

FIG. 8A is an illustration of an exemplary “Single Element Broadcast”, FIG. 8B is an illustration of an exemplary elementwise vector multiplication for Single Element Broadcast, FIG. 8C is an illustration of an exemplary “Double Elements Interleaving Broadcast”, FIG. 8D is an illustration of an exemplary elementwise vector multiplication for Double Elements Interleaving Broadcast, FIG. 8E is an illustration of an exemplary “Quad Elements Interleaving Broadcast”, FIG. 8F is an illustration of an exemplary elementwise vector multiplication for Quad Elements Interleaving Broadcast, in accordance with an embodiment of the present invention;

FIG. 8A is an illustration of an exemplary “Quad Weight Broadcast”, FIG. 8B is an illustration of an exemplary elementwise vector multiplication for Quad Weight Broadcast, in accordance with an embodiment of the present invention;

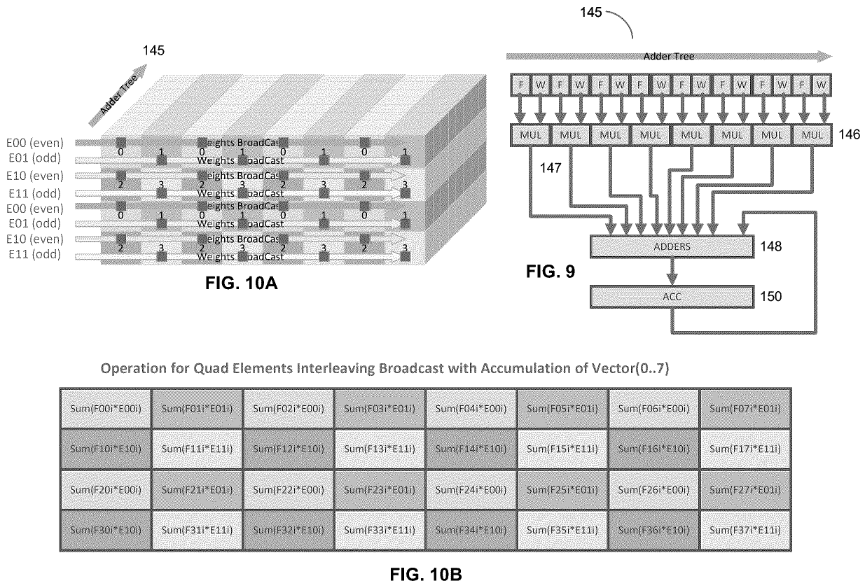

FIG. 9 is an illustration of an exemplary adder tree and accumulator, in accordance with an embodiment of the present invention;

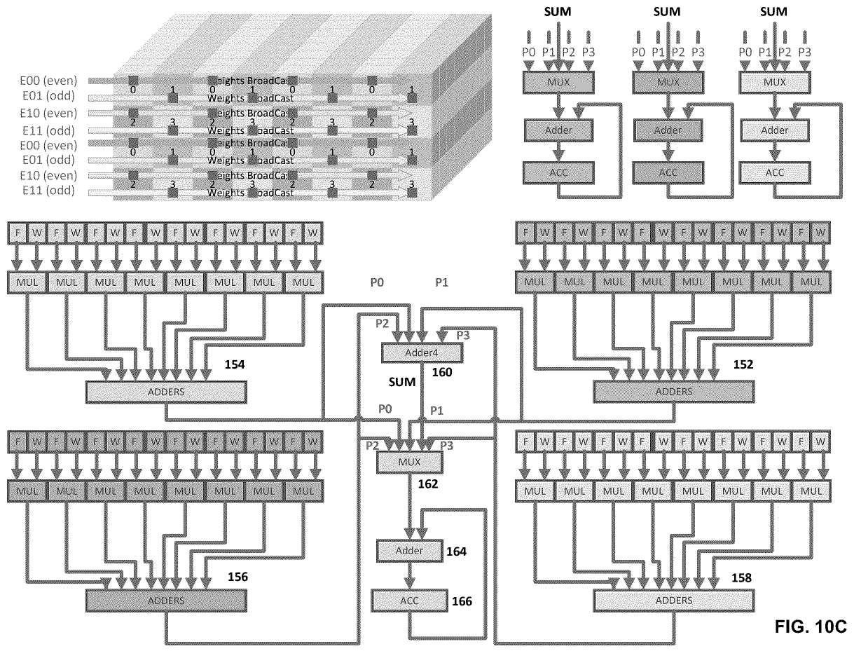

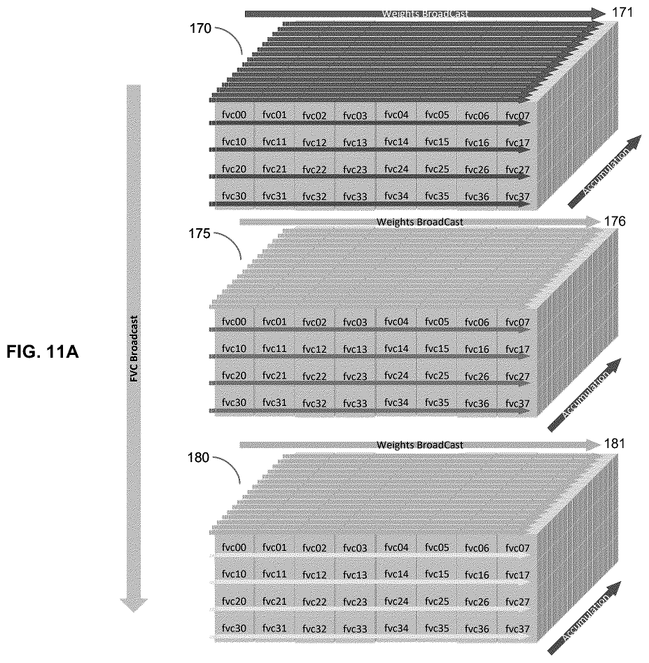

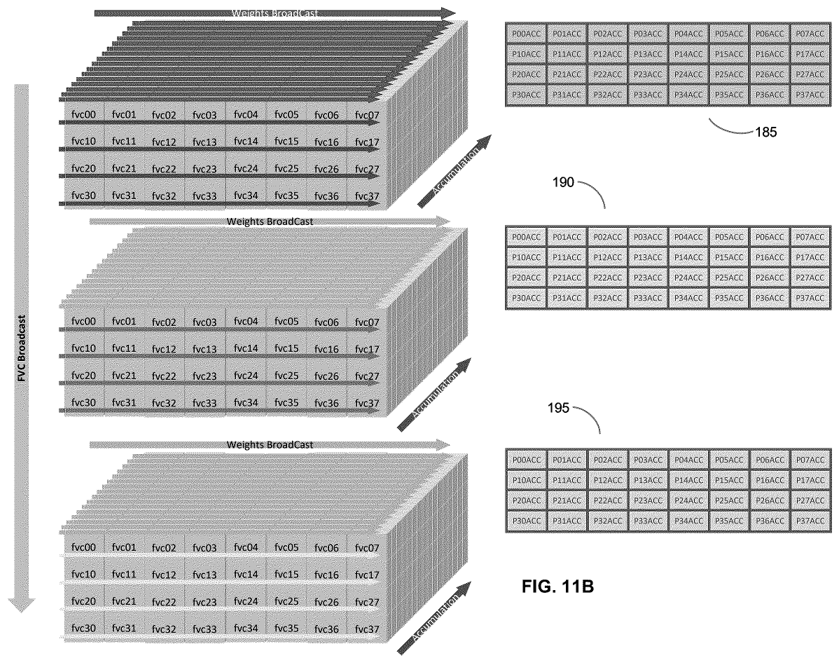

FIG. 10A is an illustration of an exemplary Quad Elements Broadcast and FIG. 10B is an illustration of an exemplary Operation for Quad Elements Interleaving Broadcast with Accumulation of Vector (0 . . . 7), in accordance with an embodiment of the present invention;

FIG. 10C is an illustration of an exemplary four (4) adder tree into Quad Pixels, in accordance with an embodiment of the present invention;

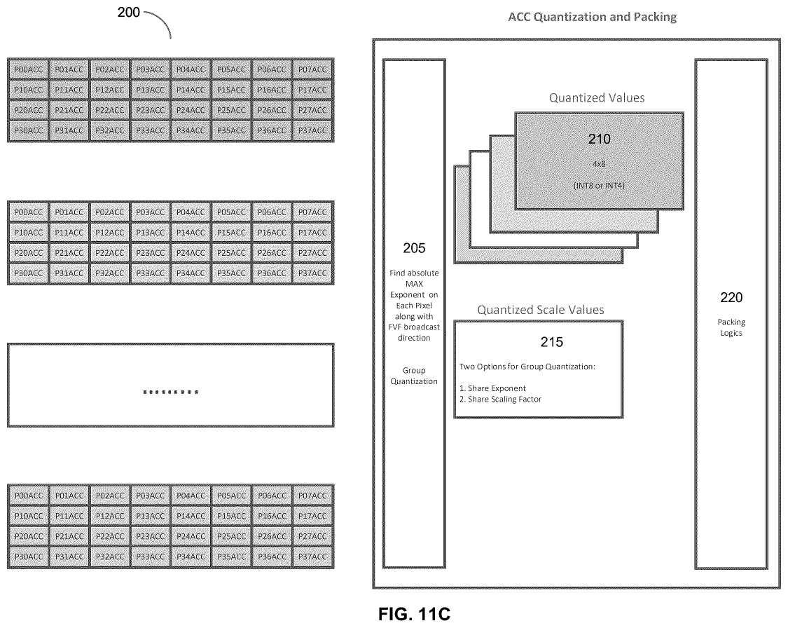

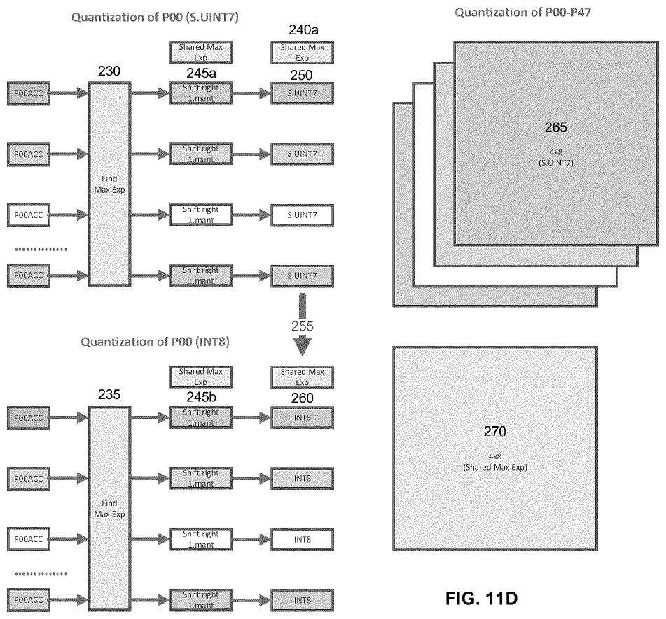

FIG. 11A and FIG. 11B are illustrations of exemplary “FTC broadcast”, in accordance with an embodiment of the present invention;

FIG. 11C is an illustration of an exemplary accumulator, in accordance with an embodiment of the present invention;

FIG. 11D is an illustration of a method for determining maximum exponents of different accumulators from various CUBEs, in accordance with an embodiment of the present invention;

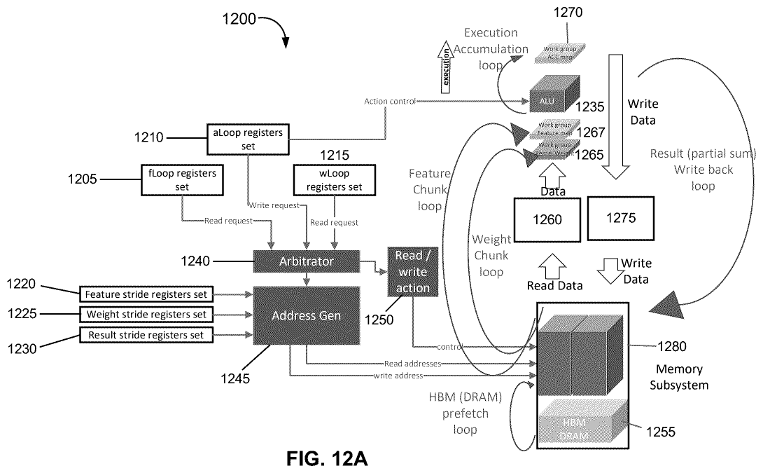

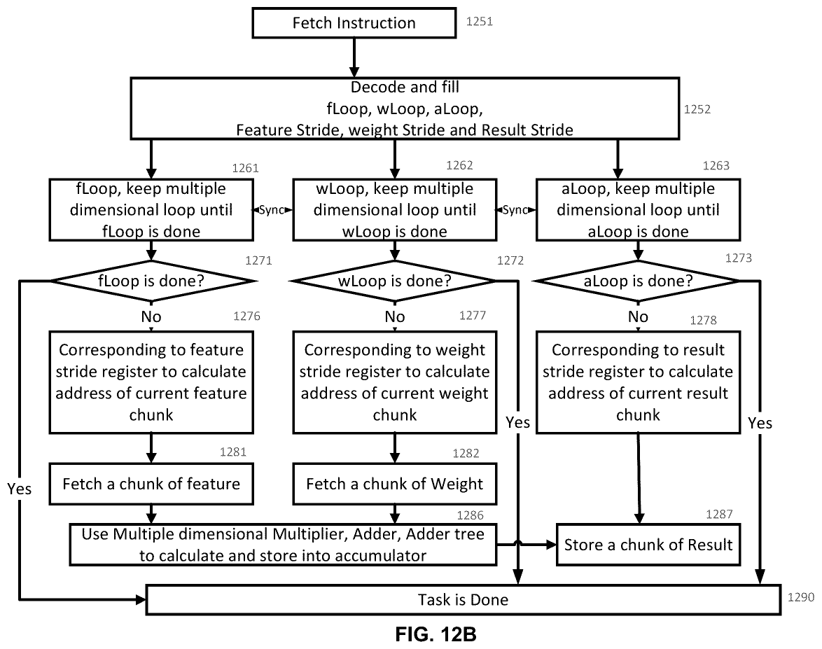

FIG. 12A is an exemplary block level diagram of a DFPU architecture and data flow, in accordance with an embodiment of the present invention;

FIG. 12B is an illustration of an exemplary flowchart of a Data Flow system process, in accordance with an embodiment of the present invention;

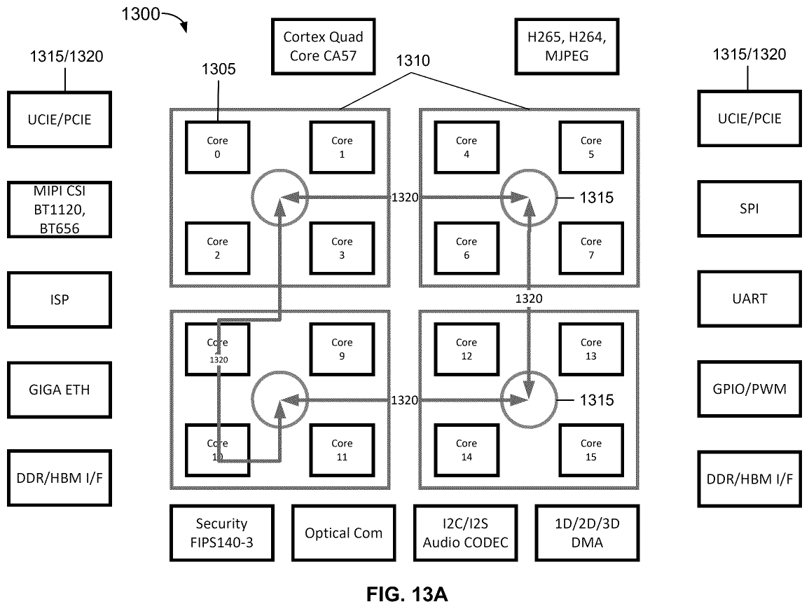

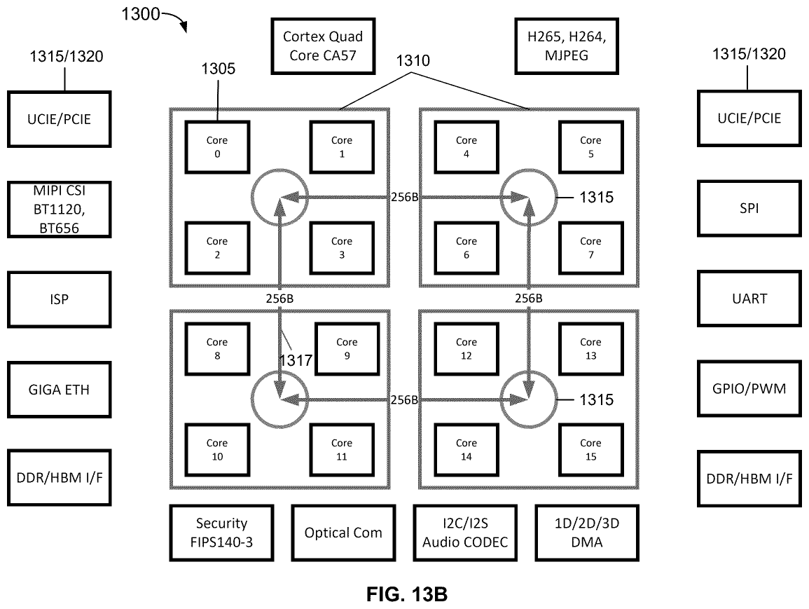

FIG. 13A and FIG. 13B are illustrations of an overview of a System-on-Chip (SOC) 1300, in accordance with some embodiment of the present invention;

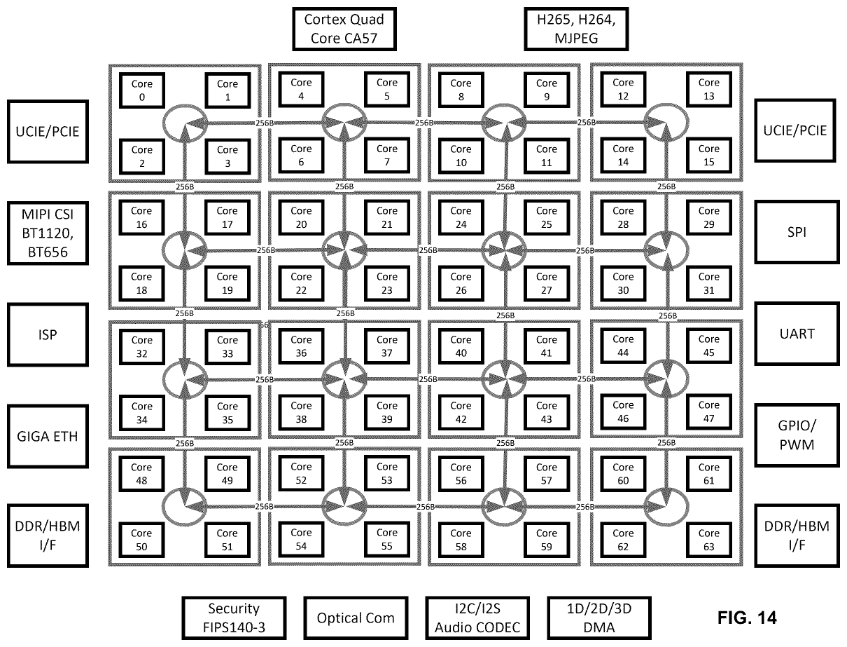

FIG. 14 is an illustration of a larger-scale system (than the system shown in FIG. 13), with 64 high-dimensional cores interconnected via a Mesh network boasting a 256-byte bus width, in accordance with some embodiment of the present invention;

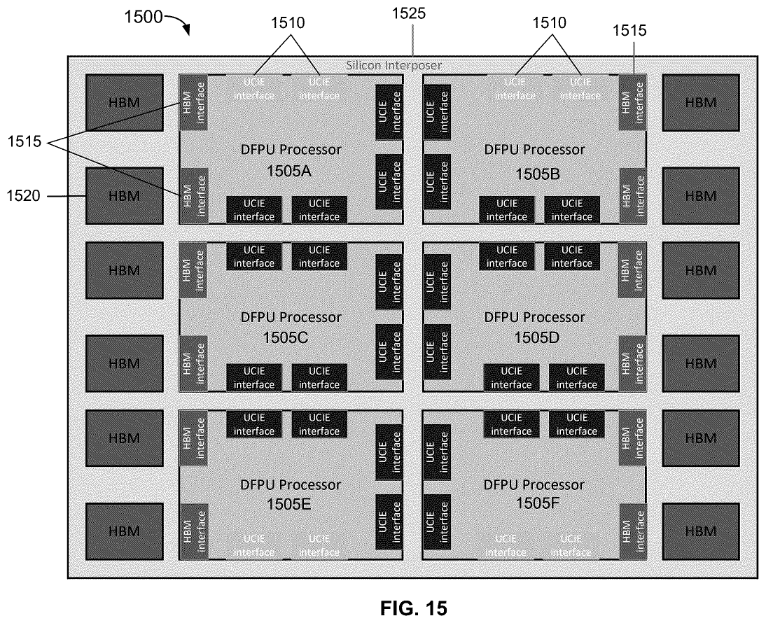

FIG. 15 illustrates an exemplary seamless integration of 6 DFPU processors through UCIE interfaces, in accordance with an embodiment of the present invention;

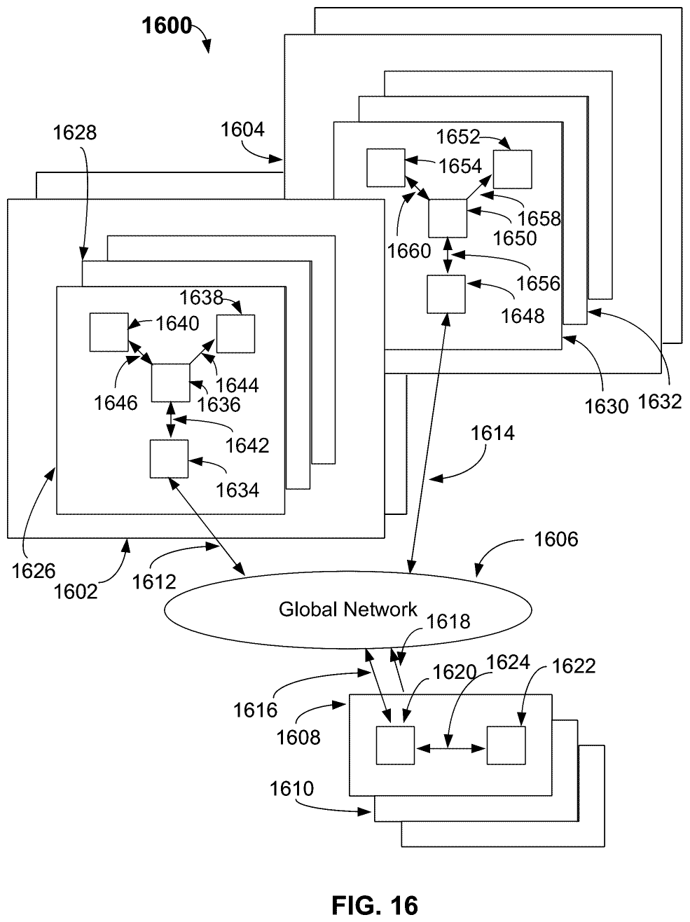

FIG. 16 illustrates a block diagram depicting a conventional client/server communication system, which may be used by an exemplary web-enabled/networked embodiment of the present invention;

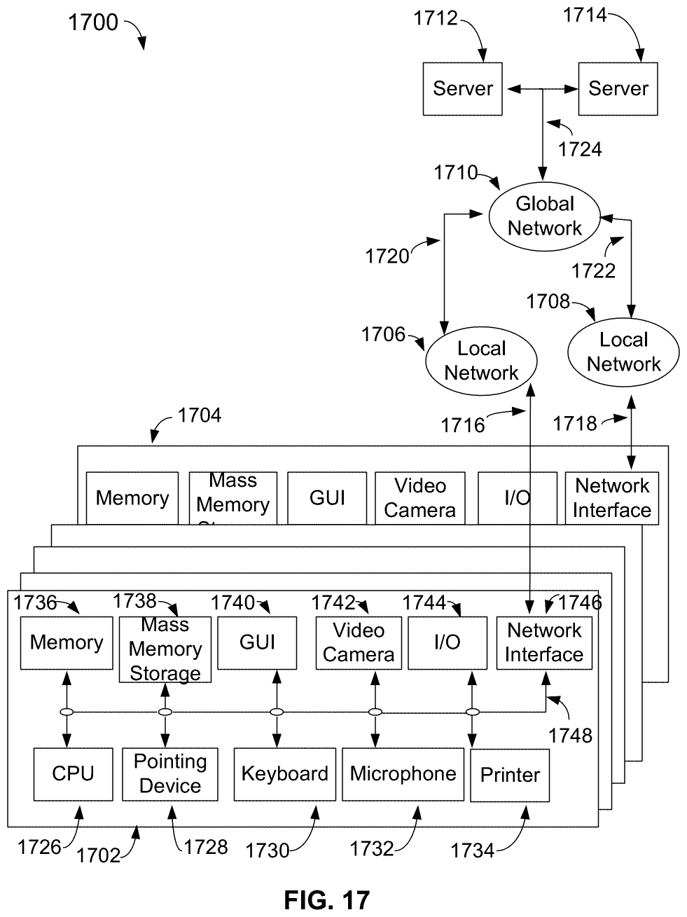

FIG. 17 is a block diagram depicting an exemplary client/server system which may be used by an exemplary web-enabled/networked embodiment of the present invention;

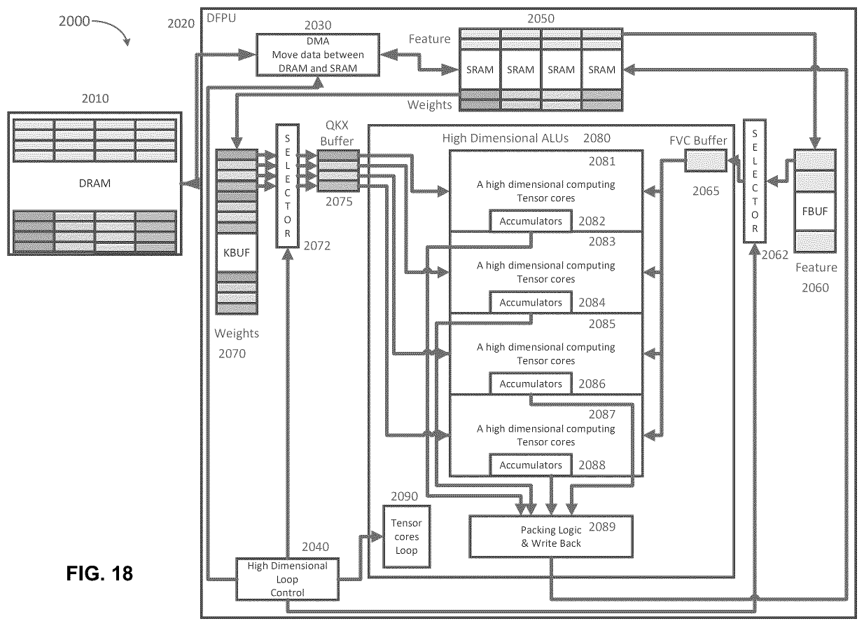

FIG. 18 illustrates exemplary system modules architecture diagram for distributing weight and feature map data, in accordance with an embodiment of the present invention; and

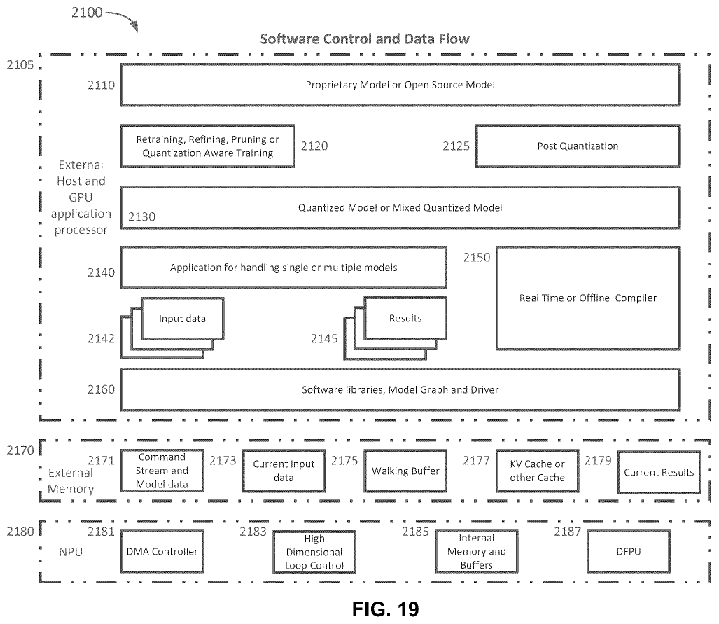

FIG. 19 illustrates exemplary software and system modules operable for software control and data flow, in accordance with an embodiment of the present invention.

Unless otherwise indicated illustrations in the figures are not necessarily drawn to scale.

### DETAILED DESCRIPTION OF SOME EMBODIMENTS

The present invention introduces a revolutionary high-dimensional computing architecture specifically tailored for Neural Processing Units (NPUs). Unlike conventional NPUs that predominantly handle vector data, the innovation seamlessly extends to support multi-dimensional tensors efficiently, with the capability to surpass the limitations of 4 dimensions. The present invention is best understood by reference to the detailed figures and description set forth herein.

Multi-Dimensional SIMD Architecture: The NPU features a novel extension of the Single Instruction, Multiple Data (SIMD) architecture to multiple dimensions, enabling concurrent processing of tensors with flexibility beyond the conventional 4 dimensions. This adaptable architecture empowers the unit to handle varying degrees of complexity in data structures, offering a scalable solution for applications requiring higher-dimensional tensors.

Optimized Tensor Processing: The NPU is meticulously optimized for tensor manipulation, ensuring that operations on multi-dimensional tensors are executed with exceptional efficiency. The architecture is designed to accommodate the intricacies of Convolutional Layers, Linear Layers, and Matrix Multiplication Layers, making it suitable for a broad spectrum of neural network architectures.

Data Flow Computing Integration: To further enhance computational efficiency, the innovative NPU incorporates advanced Data Flow Computing techniques. This integration reduces SIMD operations to a Single Instruction per layer, optimizing the execution of neural network operations and mitigating power wastage. The approach is not restricted to 4 dimensions and can seamlessly extend to higher dimensions with additional computational cycles.

Versatility and Performance: The innovative architecture and techniques make the innovative NPU highly versatile, addressing the growing demand for efficient processing of diverse, high-dimensional data structures. The unit demonstrates superior performance, particularly in applications requiring intricate tensor manipulations, such as deep learning tasks and scientific simulations.

Scalability Beyond 4 Dimensions: With the capacity for additional cores or computational cycles, the innovative NPU is not limited to 4 dimensions. It can seamlessly scale to 8 dimensions or beyond, adapting to the evolving requirements of cutting-edge computational tasks. This scalability ensures that the innovative NPU remains at the forefront of high-dimensional computing, providing a future-proof solution for emerging applications.

The innovative high-dimensional computing NPU represents a paradigm shift in processing capabilities, offering a dedicated and scalable solution for the challenges posed by multi-dimensional tensors in neural network computations. The integration of multi-dimensional SIMD architecture and Data Flow Computing positions the innovation as a versatile and forward-looking solution in the rapidly evolving landscape of neural processing units (NPUs).

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):
“Comprising” And “contain” and variations of them-Such terms are open-ended and mean “including but not limited to”. When employed in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).
“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.
“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that may be capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks may be performed by local and remote processing devices that may be linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and/or textual instructions; applets; pre-compiled code; interpreted code; compiled code; and computer programs.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces to a variety of operating systems. Although not limited thereto, computer software program code for carrying out operations for aspects of the present invention may be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network may be a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet may be a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer may read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases may be described, it will be understood by one of ordinary skill in the art that (i) alternative database structures to those described may be readily employed, (ii) other memory structures besides databases may be readily employed. Any schematic illustrations and accompanying descriptions of any sample databases presented herein may be exemplary arrangements for stored representations of information. Any number of other arrangements may be employed besides those suggested by the tables shown. Similarly, any illustrated entries of the databases represent exemplary information only; those skilled in the art will understand that the number and content of the entries may be different from those illustrated herein. Further, despite any depiction of the databases as tables, an object-based model could be used to store and manipulate the data types of the present invention and likewise, object methods or behaviors may be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Chrome, Edge, Internet Explorer, Safari, FireFox, or the like), but should be broadly construed to refer to any client-side rendering engine that may access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and may be merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” may include generic structure (e.g., generic circuitry) that may be manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that may be adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media may be any available media that may be accessed by a general purpose or special purpose computer, including the functional design of any special purpose processor as discussed above. By way of example, and not limitation, such non-transitory computer-readable media may include RAM, ROM, EEPROM, CD-ROM or other optical disk storage, magnetic disk storage or other magnetic storage devices, or any other medium which may be used to carry or store desired program code means in the form of computer-executable instructions, data structures, or processor chip design. When information may be transferred or provided over a network or another communications connection (either hardwired, wireless, or combination thereof) to a computer, the computer properly views the connection as a computer-readable medium. Thus, any such connection may be properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself may be transitory.

In some embodiments of the present invention and variations thereof, relate to high-dimensional computing architectures for artificial intelligence (AI) systems. In one embodiment of the present invention, the system and method enables the broadcasting of same weights to different features or the same feature to different weights, extending traditional 2-dimensional calculations into higher dimensions.

In other embodiments, the system may include storing partial or full weights and feature maps in multiple memory banks including SRAM, MRAM, embedded DRAM, Flash memory, or RRAM memory. A portion of the weight may be fetched from memory and stored into a weight buffer, which may include multiple input and output channels or multiple rows or columns of weights. The chunk of weight may be placed into a broadcasting buffer, where it is colored by various colors, contributing to different regions of operations. Each region supports three-dimensional or higher-dimensional computing operations.

The broadcast buffer may hold weights in two dimensions, with one dimension representing the input channel or rows/columns of weight and the other dimension used for input, output, filter size, row, or column of weights. The two-dimensional broadcasting buffer maps and broadcasts into three-dimensional computing cells. Output channels may be broadcasted into different three-dimensional computing cells.

In further embodiments, the invention introduces feature distribution and broadcast. A chunk of feature from multiple banks of SRAM is stored into a feature/vector context buffer (FVC buffer), which may be a two-dimensional or three-dimensional feature map. The chunk may be distributed and broadcast along different three-dimensional computing cells, enabling four-dimensional computing using broadcasted weights and features.

The system provides the ability to share weights and feature maps across multiple dimensional computing cells simultaneously, eliminating the need for frequent fetching and storing into SRAM and DRAM. The approach may significantly reduce power consumption.

In alternative embodiments, the system may include a pipeline based FVC broadcast, where the feature map propagates cycle by cycle through three-dimensional computing cells, maintaining the pipeline flow for four-dimensional computing per cycle. By extending to multiple cores or chips, the architecture supports very high-dimensional computing. High-dimensional computing may be achieved by broadcasting both feature maps and weights simultaneously, broadcasting weights while pipelining feature maps, or pipelining weights while broadcasting feature maps in more than three-dimensional computing cells.

The method may include broadcasting weights of different input and output channels through multiple-dimensional computing cells. Each cell connects to the FVC Buffer via broadcast or pipeline. The weight buffer holds rows of input channels, and the weights are broadcasted to form an element-wise multiplication and adder tree summing up the results. The system achieves at least three-dimensional or four-dimensional operations, with the potential for multiple high-dimensional computing results using more cores.

The advanced data processing method may involve reshaping matrices into three-dimensional tensors and performing block-wise matrix multiplications to produce output tensors. The algorithm fetches model layers, distributes weights and feature maps to the high-dimensional computing architecture, and synchronizes the operations to handle weight and feature blocks efficiently.

In some embodiment, the system may incorporate a group quantization scheme, where quantization is performed per tensor, per channel, or per group, sharing the scaling factor among the respective granularity levels. Accuracy may be improved while requiring extra storage for the scaling factor. The quantized values may be packed into a three-dimensional feature map, further enhancing processing efficiency.

The high-dimensional computing architecture significantly outperforms traditional technologies such as, without limitation, CPUs and GPUs, that are ideal for high computing demands. The architecture may provide the scalability required to tackle the increasing complexity of AI tasks by utilizing multiple cores, chip-to-chip communication, multiple boards, and multiple systems.

The system encompasses various configurations for broadcasting weights and features, performing element-wise multiplication, and accumulation using an adder tree, ensuring high-dimensional computing performance and flexibility.

The present invention will now be described in detail with reference to embodiments thereof as illustrated in the accompanying drawings.

FIG. 1 is an illustration of an exemplary Multiple Dimensional computing architecture for AI computing, in accordance with an embodiment of the present invention. In one embodiment of the present invention, partial or full weights tensor data and feature map data may be stored in a multiple bank memory 105. In AI, feature maps refer to the initial set of input data and the intermediate results computed at each hidden layer. As the data progresses through each hidden layer, feature maps are generated until the final output tensor is produced. These intermediate and final outputs are collectively called feature maps. The weights, on the other hand, are the trainable parameters assigned to each layer, which adjust throughout training to optimize the model's performance. Multiple bank memory 105 may include, without limitation, SRAM, MRAM or any type of embedding memory like embedded DRAM, Flash memory or RRAM. A portion of weight data may be fetched from memory 105 and stored into a weight buffer 110. The weights are normally called the parameters. Weights may be trainable parameters on a model training. For a model inference, quantization or pruning may be applied to reduce the size of parameters. The portion of weight tensor data may include, without limitation, multiple input and output channels or multiple rows and/or cols of weights. From weight buffer 110, a chunk of weight may be fetched and placed into broadcast buffers 117 118 119 and then broadcast into computing units 120a-c. Each broadcast buffer may include, without limitation, multiple input and/or output channels or rows and/or cols of weights (presented by different colors). For example, without limitation, each broadcast buffer 125a-c may include sixteen (16) output channels, four (4) rows and eight (8) columns of weights. The weights may have different output channels, where each output weight channel contributes into different regions of operations. Each region 120a-120c has a 3-dimensional or beyond 3-dimensional computing operations. Each broadcast buffer holds the weights having a two-dimensional weight. One of the dimensions labelled as “ABCDEFGH . . . P” of broadcast buffer holds the input channel or rows of weight tensor data which is going to multiply with the feature map data, sum up and stored into the accumulation. The first dimension, which direction is shown as “ABCDEFGH . . . P” 115. The other dimension, which direction is column labelled as “0123” in box 117 will do a broadcast into row 116 of box 120a. Three-dimensional broadcasting buffer 110 may be tiled as a 2D weight 117, and then mapped and broadcast into a 3-dimensional computing cell 120a along with the “weights broadcast” 125a. Each 3-dimensional computing cell 120a 120b 120c could be a group of ALUs or a group of MACs operation with an adder-tree in channel accumulation direction 140. Using the same scheme, the other output channels 118 and 119 are broadcasted along with “weights broadcast” 125b and 125c into 3-dimensional computing cells 120b and 120c.

In some embodiments of the present invention, the feature map data distribution and broadcast may include fetching (shown as arrow 135) a chunk of feature map data from multiple bank memory 105 and stored into a feature vector context (FVC) buffer device 130. The feature map data may comprise an input tensor or a hidden layer feature. The hidden layer is generated after a layer is calculated. The hidden layer is an output feature from the calculation. The hidden layer becomes an input tensor of the next layer. The input tensor or hidden layer may comprise the feature map data. The chunk of feature map may include, without limitation, a two-dimensional feature map or three-dimensional feature map. The feature map(s) may be distributed and broadcasted to 3-dimensional computing cells 120a 120b 120c following the arrow direction “FVC Broadcast” 145. The feature map data may be stored as 1-dimensional memory for 3-dimensional features. For example, the dimensional size (height, width, depth) and the location of the element described as (y, x, z). The location (y, x, z) is within (0 . . . height, 0 . . . width, 0 . . . depth). The address of current element=y*width*depth+x*depth+2 may be stored in the 1-dimensional memory. The feature map data may also be stored as 3-dimensional memory for 3-dimensional features. The only difference will be the address of the element. The address of current element=y*width_stride+x*depth_stride+z. The width_stride and depth_stride, instead of width and depth may help to make it more flexible and the padding size may be controlled without needing a contiguous memory space. There are many different formats and many kinds of shapes that may be stored in memory. Not limited to just the example listed. Now, operations of a four-dimensional computing may be performed by using the broadcast weights and features. Feature maps may be broadcasted to computing cells 120a, 120b, 120c. The weight tensor data of different output channels 117, 118 and 119 may be broadcast to computing cells 120a, 120b and 120c individually. Weight data and feature map data may be broadcast simultaneously within a single cycle. The 3-dimensional feature map with different output channels of weight tensor data may form, without limitation, a 4-dimensional computing. Each computing region 120a-c doing the computing operation parallelly. The structure of the computing regions 120a-c is illustrated in FIG. 2, section 160. Each location labeled fvc00 through fvc37 contains a complete structure as shown in FIG. 2, 160. For region 120a, there are a total of 4×8 instances of the structure depicted in FIG. 2, 160. Each computing region 120a-c performs computing operation including, without limitation, optimized tensor manipulation, ensuring that operations on multi-dimensional tensors are executed with exceptional efficiency because an element of weight or feature is significant broadcast and used by the computing architecture.

In an alternative embodiment of the present invention, “FVC Broadcast” 145 may be Pipeline-based. Instead of broadcast, a method of pipeline is provided. The feature map(s) may be distributed and pipelined to 3-dimensional computing cells 120a 120b 120c following the arrow direction “FVC Broadcast” 145. The method of “FVC Broadcast or Pipelines” 145 depends on the physical layout. If the timing is very critical for broadcast, pipeline method may be chosen. In each cycle, the feature map may be propagated cycle by cycle from the first 3-dimensional computing cell 120a to the next 3-dimensional computing cells 120b and 120c. The flow of the pipeline and the new feature map follows the pipelines. At least four-dimensional computing per cycle may be achieved. The pipeline is a set of data processing elements connected in series, so that the output of one element is the input of the next one. The pipeline is a series of processing stages, where each stage performs a specific task on data and passes it to the next. Data flows continuously through the stages, with each stage working in parallel on different pieces, making processing fast and efficient. This setup is ideal for real-time tasks, as it quickly prepares data for computing or output.

The diagram shows a core which includes, without limitation, computing regions 120a, 120b and 120c. Computing region 120a may comprise 3-dimensional regions. Regions 120a, 120b and 120c may be counted as another dimension because the regions may calculate different weight's output channel by using the same feature map data. The 4-dimensional computing array which may be called a core may speed up computing and use the same feature map at the same time. The computing regions may reduce energy because the feature data is fetched once and the feature may be reused as many times as possible in register level. It is not limited to four dimensions. The method may include multiple cores to extend the high-dimensional computing cells. If the core is extended to multiple cores or multiple chips, a very high dimensional computing may be achieved. Alternatively, a single core and using multiple cycles may achieve a high dimensional computing.

As shown and described, the high dimensional computing architecture may include the simultaneous broadcast of feature map and weights, simultaneous broadcast of weight and pipelining feature map, or simultaneous pipelining weights and broadcasting feature map in more than one (1) three-dimensional computing cells.

FIG. 2 is an illustration of an exemplary broadcast of weights of different input and output channels through multiple-dimensional computing cells, in accordance with an embodiment of the present invention. In an embodiment of the present invention, stored feature map from “FVC Buffer” 130 may be transferred to computing cell 120a either thru broadcast or pipeline “FVC Broadcast/Pipeline” 145. Feature map data may be labelled as “fvc00-fvc07”, “fvc10-fvc17”, “fvc20-fvc27”, and “fvc30-fvc37”. Each feature map data (fvcnm) has, without limitation, 16 input channels. Each input channel comprises, without limitation, 4 rows and 8 columns (e.g. row is from 0 to 3, column is from 0 to 7). As shown in the diagram, weight buffer 117 holds 4 rows of 16 channels “ABCDEFGH . . . P”. The weights may be broadcast from (4 rows, 16 channels) to (4 rows, 8 columns, 16 channels). Then a summation of elementwise multiply may be performed along the channels. Along the input channels, an elementwise multiply and adder tree 160 of 16 channels is as follows:

$$sum ( F * W + F * W + F * W … F * W ) + previous ACC = > new ACC$$

After the above operation, the resultant values may be stored in a 4×8 accumulator 150. Final data may be determined through iterations of feature map (F) and weight (W) operations. In such operation, at least three-dimensional operations may be performed. Furthermore, with the previous high dimensional computing cells, at least three-dimensional data may be calculated simultaneously. With more cores, multiple high dimensional computing result may be achieved simultaneously.

In some embodiment of the invention, the system may include high dimensional broadcast with adder tree 160 having a multiplier implement 159 for an input channel or row and/or col elementwise multiply 153 and an adder implement 157 to sum up the result of elementwise multiply 153. Moreover, accumulator (ACC) implement 150 may accumulate multiple cycles of the result.

FIG. 3 is an illustration of exemplary matrices for distributing weight and feature map data in a high dimensional architecture, in accordance with an embodiment of the present invention. In one embodiment, two matrices, Matrix A 305 and Transposed Matrix B 310, each may be reshaped to three-dimensional tensors 315 320. FIG. 3 shows a Matrix A 305 with a shape 8×64. Matrix A may be reshaped to be 8×8×8 Matrix A′ 315. Then 3D dimension may be used to do operation instead of 2D dimensions. The 8×8×8 matrix may be chopped into two (2) 4×8×8 matrices and use the multiple dimensional computing in FIG. 2, 130. Then a broadcast or pipeline of FVC buffer may be performed into 3-dimensional computing 120a. The accumulator and adder tree may be used to do summation of elementwise multiplication in depth direction shown in FIG. 2, 140 and adder tree 160. A portion of a block may be defined as, for example, without limitation, 8 rows, 8 columns and 8 depths. The size 8 columns, 8 rows, 8 depths may be changed in different modes. For example, without limitation, the 2D matrix may be reshaped into a cube. The cube may include, without limitation, 8×8×8 cube. The cube may be reshaped into a different shape in 3D according to the ALU design. Each Matrix may slice into many blocks and each block may cut into many portions. With this definition, the algorithm of distributing the weight and feature map in high dimensional architecture may be performed. With the reshape function, the matrix may be reshaped into 3D dimension. The depth dimension of the 3D dimension is associated with the size of adder tree. In the example, without limitation, the depth is 8. The depth could be 16, 32 or any kind of number.

FIG. 4 is an illustration of an exemplary matrix multiplication, in accordance with an embodiment of the present invention. In one embodiment, a portion 405 of ‘A Block’ of matrix A 305 may be multiplied with a portion 410 of ‘A Block’ of transposed matrix B 310 to arrive at a sum of a partial chunk of output tensor 415. In a “matrix A stagnant” arrangement, a (e.g., first) ‘A Block’ of a matrix A may be multiplied with a block of transposed matrix B to get a (e.g., first) partial chunk of output tensor 415. The same (e.g., first) ‘A Block’ of matrix A may be multiplied with another block of transposed matrix B, resulting in another (e.g., second) partial chunk of output tensor. The same process may be repeated using the same (e.g., first) block of matrix A until all ‘A Blocks’ of transposed matrix B are multiplied to get a collection/block of output tensors (e.g., first block of next level input tensor 420). Another (e.g., second) ‘A Block’ of matrix A may be multiplied with the portions of a block of transposed matrix B 410 resulting in a partial sum of a chunk of output tensor 415. Replicating the procedure above may affect in another collection/block of output tensors (e.g., second block of next level input tensor 420).

FIG. 5A is an illustration of an exemplary flowchart of a weight stagnation and FIG. 5B is an illustration of an exemplary flowchart of a feature map stagnation, in accordance with an embodiment of the present invention. In one embodiment, the exemplary flowcharts of the algorithm may fetch a data model in a Step 502, may fetch a data layer from the model in a Step 504 and distribute the weights and feature map to the high dimensional computing architecture.

Referring to FIG. 5A, a flowchart of a weight stagnation is exemplified. For example, without limitation, in the case of an internal memory bank SRAM that is not large enough to hold the whole weight tensor data and feature map data. The algorithm may fetch a block of weight tensor data, then fetch a block of feature map at a time and execute a matrix multiplication. In a Step 504, get a data layer of a model 502. In a Step 506, a stored block of weight tensor data is fetched from DRAM (e.g. external memory bank) to SRAM (e.g. internal memory bank). Then, in a Step 508, sync together and do both routes together. The synchronization scheme relies on the valid bits of the data. When both the weight and feature map data are available, the operation is triggered. If cither the weight or feature map data is unavailable, the system waits until both data sets have arrived. Once both are ready, the operation begins. In a Step 510, a portion of a weight block is fetched from weight buffer, then in a Step 512, the portion of weight data is broadcasted to multiple dimensional computing architecture. In a Step 516, a block of feature map may be fetched from either DRAM or SRAM. A portion of the block is fetched in a Step 518 and then broadcast to high dimensional computing architecture in a Step 520. A partial sum of a chunk may be calculated in high dimensional architecture. Then, in a Step 514, a calculate/sync is performed to make sure the weight and feature are available for calculation. In a Step 522 is to check whether the whole input channel or feature has been fetched and calculated. If not (No), both branches will fetch new portions of the blocks, one from weight tensor data in Step 510 and the other from feature map in Step 518. Then in Step 512 and Step 520, these portions are broadcast to the high dimensional architecture and calculate/accumulate the partial sum. In a Step 522, if the whole block is done (Yes), chunk of result may be stored into SRAM or DRAM in Step 524. Step 526 is to check whether all blocks of feature tensors are fetched. If all feature blocks are done and multiply with the current block of weight, a block of output tensor is done. If not, we loop back and fetch the next block of feature map starting in Step 508, then doing the above steps until the whole feature map is done. In a Step 528, a check is made whether all the blocks of weights are fetched. If not (No), the next block of weight is fetched in Step 506 and subsequent loops are performed until all blocks of weight are operated on. If all the weights in the layer are fetched (Yes), that means all the weights are multiplied with all the feature tensors resulting with the output tensor, and the result of all output tensor is/are determined. Then, in a Step 530, a check is conducted to determine whether all layers of the model have been processed. If not (No), a block of weight of a next layer of the model is fetched from memory and processed in a Step 504, until all the stored data layers of the model are processed. If all layers of the model have been processed (Yes), then a new model may be processed in Step 502.

Referring to FIG. 5B, a flowchart of a feature map stagnation is exemplified. For example, without limitation, in the case of an internal SRAM that is not large enough to hold the whole weight data and feature map data. The algorithm holds a block of feature tensor, then get a block of feature at a time and may do matrix multiplication. First, a block of tensor may be fetched from DRAM to SRAM in a Step 532. Then, in a Step 534, the routes are sync together and do both routes together. One route fetches a portion of a block from feature map in a Step 542, then the portion may be broadcasted to the multiple dimensional computing architecture in a Step 544. The other route fetches a block of weight cither from DRAM or SRAM in a Step 536. A portion of the block may be fetched in Step 538 and broadcasted to the high dimensional computing architecture in Step 540. Both routes may be sync in a Step 546 and calculated in the high dimensional architecture to get a partial sum of a chunk. Then calculate/sync and check whether the whole block of weight and feature is processed. A check is performed to determine if the whole input block is fetched in a Step 548. If the result is Yes, then a chunk of result may be stored into SRAM or DRAM. If not (No), a new portion of the blocks, one from weight (Step 538) and the other from feature map (Step 542), arc fetched, broadcasted to the high dimensional architecture (Steps 540 and 544) and calculate/accumulate the partial sum (Step 548). The next step (Step 552) is to check whether to keep fetching the next block of weight or all blocks of weights have been processed. If all weights blocks are processed (and multiply with the current block of feature map) (Yes), a block of output tensor is produced. If not (No), loop back and fetch the next block of weight in Step 534. Steps 538-552 performed until the whole weights are done. Step 554 checks whether every block of feature tensor is fetched. If done (Yes), the whole weights multiply with whole feature tensor and get the result of whole output tensor. If not (No), the next block of feature map is fetched in Step 532 and do the above loops until all blocks of feature map are done. Then, move to a next check box (e.g. Step 556) to check whether all layers of the model are done. If all layers of the model are not done (No), the next layer is fetched in Step 504 until all layers are processed. If all layers of the model are processed (Yes), then a new model may be processed in Step 502.

There are many ways to do weights broadcasting. One of the alternatives is using “single weight/vector broadcasting”. Please note the three-dimensional broadcasting. The diagram shows only width and height direction. The single weight is used to broadcast to (h, w)=(4, 8) region. However, there is another dimension in a Z direction. The row/col or input channel may be defined as a vector. In the example, without limitation, the vector size is 16. The vector size could be any size.

FIG. 6A is an illustration of an exemplary “Single Weight Broadcast” matrix, in accordance with an embodiment of the present invention. Referring to FIG. 6A, the diagram shows that w0 vector broadcasts to all the computing cells (4, 8) that is corresponding to the feature elements of F00-F07, F10-F17, F20-F27 and F30-F37.

FIG. 6B is an illustration of an exemplary elementwise vector multiplication, in accordance with an embodiment of the present invention. The bottom of FIG. 6B shows that w0 vector will do elementwise multiply individually with F00, F02, . . . F06, F10, F12, . . . F16, F20, F22, . . . F26 and F30, F32, . . . F36. and w1 vector will do elementwise multiply individually with F01, F03, . . . F07, F11, F13, . . . F17, F21, F23, . . . F27 and F31, F33, . . . F37. The adder tree and accumulator may be utilized to sum up the result of elementwise multiply.

FIG. 6C is an illustration of an exemplary “Double Weight Interleaving Broadcast” matrix, in accordance with an embodiment of the present invention. The bottom of FIG. 6C shows that a w0 vector and w1 vector interleaved broadcasting into the height and width area (4, 8). It is a three-dimensional computing structure. W0 vector broadcasts to Even location(s) of x (width) direction. W1 vector broadcasts to Odd location(s) of x (width) direction.

In some embodiment, FIG. 6C has, without limitation, two vectors of weights: w0 vector and w1 vector. The matrix may apply to the 2D convolution with a stride 2. Even tap vector of a filter applies to even location, the odd tap vector of a filter applies to odd location.

FIG. 6D is an illustration of an exemplary elementwise vector multiplication, in accordance with an embodiment of the present invention.

FIG. 7A is an illustration of an exemplary “Per Row Weight Broadcast”, in accordance with an embodiment of the present invention. Referring to FIG. 7A, previously, the three-dimensional broadcasting was shown. The diagram shows a width and a height direction, where a four-vector weight broadcast to (h, w)=(4, 8) region. There is another dimension in a Z direction. A vector on the Z direction could be input channels, a partial of row or col in a matrix. For example, without limitation, the vector size may be more or less 16. The vector size could be any size. The diagrams shows that w0 vector broadcasts to F00, F01, . . . F07; w1 vector broadcast to F10, F11, . . . F17; w2 vector broadcast to F20, F21, . . . F27; w3 vector broadcast to F30, F31, . . . F37.

FIG. 7A has four different portions of weights, but FIG. 6A only has same portions of weights. In neural network, there are many different types of operations or different size of optimization in memory. In a ID Convolution operation, there may be 32 input channels. In FIG. 2, the adder tree is only 8 input channels. The 4 rows may be used to represent 4 different 8 input channels (total is 32 input channels). In this case, four (4) different weights w0-w3 was broadcasted. Then the value per column is added together. For FIG. 6A, it applies to matrix multiplication or convolution 2D with a portion of the weight to apply the multiplication with the feature map.

FIG. 7B is an illustration of an exemplary elementwise vector multiplication for Per Row Weight Broadcast, in accordance with an embodiment of the present invention. FIG. 7B shows that w0 vector may elementwise multiply individually with F00, F01, . . . F07; w1 vector may elementwise multiply individually with F10, F11, F12, . . . F17; w2 vector elementwise multiply individually with F20, F21, F22, . . . F27; and w3 vector may elementwise multiply individually with F30, F31, F32, . . . F37. The adder tree and accumulator may be utilized to sum up the result of elementwise multiply.

FIG. 6B and FIG. 7B are associated with FIG. 6A and FIG. 7A. FIG. 6A and 7A represent the weight broadcast. FIG. 6B and FIG. 7B represent the weight broadcast and elementwise multiply with each feature map vector.

FIG. 7C is an illustration of an exemplary “Double Weight Interleaving Broadcast”, in accordance with an embodiment of the present invention. FIG. 7C shows w00 vector and w01 vector interleaved broadcasting into row0; w10 vector and w11 vector interleaved broadcasting into row1; w20 vector and w21 vector interleaved broadcasting into row2; and w30 vector and w31 vector interleaved broadcasting into row3.

In some embodiment, FIG. 7C has four vectors of weights: w00, w01, w10, w11 as compared to two vectors of FIG. 6C. The vectors may be used for the 2D convolution case with stride 2 in x and stride 2 in y. Even x and even y tap vector uses w00 and apply to location even x and even y; Odd x and even y tap vector uses w01 and apply to location odd x and even y; Even x and odd y tap vector uses w10 and apply to location even x and odd y; and odd x and odd y tap vector uses w11 and apply to location odd x and odd y.

FIG. 7D is an illustration of an exemplary elementwise vector multiplication for Double Weight Interleaving Broadcast, in accordance with an embodiment of the present invention. FIG. 7D shows w00 vector elementwise multiply individually with F00, F02, . . . F06; w10 vector elementwise multiply individually with F10, F12, . . . F16; w20 vector elementwise multiply individually with F20, F22, . . . F26; and w30 vector elementwise multiply individually with F30, F32, . . . F36; and w01 vector elementwise multiply individually with F01, F03, . . . F07; w11 vector elementwise multiply individually with F11, F13, . . . F17; w21 elementwise multiply individually with F21, F23, . . . F27; and w31 elementwise multiply individually with F31, F33, . . . F37. The adder tree and accumulator may be utilized to sum up the result of the elementwise multiply operations.

FIG. 6D and FIG. 7D are associated with the FIG. 6C and FIG. 7C. FIG. 6C and 7C represent the weight broadcast. FIG. 6D and FIG. 7D represent the weight broadcast and elementwise multiply with each feature map vector.

FIG. 7E is an illustration of an exemplary “Quad Weight Interleaving Broadcast”, in accordance with an embodiment of the present invention. In one embodiment of the present invention, FIG. 7E shows a “Quad Weight Interleaving Broadcast” where w00 vector and w01 vector interleaved broadcasting into row0; w10 vector and w11 vector interleaved broadcasting into row 1; w00 vector and w01 vector interleaved broadcasting into row2; and w10 vector and w11 vector interleaved broadcasting into row3. FIG. 7E is very similar to FIG. 7C. However, FIG. 7E repeat the weight in Quad Pixel format. Combine the information of neighbor pixels and do a reduction of the information. The Quad Pixel scheme reduces the summation process and stores the result in a designated accumulator. This scheme helps extend data liveness for both weight and feature map stagnation, effectively reducing the need for memory fetch and storage operations. The Quad pixel scheme could use in convolution stride 2 in x and y, or average pooling and max pooling, etc. When the Quad Pixel scheme is used in average pooling and max pooling mode, the vector of weights could be all ones.

FIG. 7F is an illustration of an exemplary elementwise vector multiplication for Quad Weight Broadcast, in accordance with an embodiment of the present invention. FIG. 7F shows w00 vector elementwise multiply individually with F00, F02, . . . F06; w10 vector elementwise multiply individually with F10, F12, . . . F16; w00 vector elementwise multiply individually with F20, F22, . . . F26; and w10 vector elementwise multiply individually with F30, F32, . . . F36; and w01 vector elementwise multiply individually with F01, F03, . . . F07; w11 vector elementwise multiply individually with F11, F13, . . . F17; w01 elementwise multiply individually with F21, F23, . . . F27; and w11 elementwise multiply individually with F31, F33, . . . F37. The adder tree and accumulator may be used to sum up the result of elementwise multiply. FIG. 7F is associated with FIG. 7E. The weights are in Quad Pixel format. That is, repeat a set of four vectors and apply to Quad Pixel. The reason described in FIG. 7E.

FIG. 8A is an illustration of an exemplary “Single Element Broadcast”, FIG. 8B is an illustration of an exemplary elementwise vector multiplication for Single Element Broadcast, FIG. 8C is an illustration of an exemplary “Double Elements Interleaving Broadcast”, FIG. 8D is an illustration of an exemplary elementwise vector multiplication for Double Elements Interleaving Broadcast, FIG. 8E is an illustration of an exemplary “Quad Elements Interleaving Broadcast”, FIG. 8F is an illustration of an exemplary elementwise vector multiplication for Quad Elements Interleaving Broadcast, in accordance with an embodiment of the present invention.

FIG. 8A through FIG. 8F has similar behaviors as the weight broadcasting of FIG. 7A through FIG. 7F, except instead of weight broadcasting, FIG. 8A through FIG. 8F may be directed to, without limitation, element broadcasting. The element may be any kind of vector broadcast including partial of matrix or transposed matrix or any kind of vectors.

FIG. 9 is an illustration of an exemplary adder tree 145, in accordance with an embodiment of the present invention. Adder tree 145 may include, without limitation, adder 148 and accumulator 150. Adder tree 145 may be utilized to sum up the result of elementwise multiply operations. Adder 148 is along the z direction. The tree may Multiply 147 weights (W) and features (F) and ADD 148 (MAD) the results of the elementwise multiplication of weights and features in adder 148. In some embodiments, adder 148 result may be added/stored at accumulator (ACC) 150.

FIG. 10A is an illustration of an exemplary Quad Elements Broadcast, in accordance with an embodiment of the present invention. In one embodiment of the present invention, an E00 vector and E01 vector shows interleaving broadcasting into the row0; E10 vector and E11 vector interleaving broadcasting into the row1; again, E00 vector and E01 vector interleaving broadcasting into the row2; and E10 vector and E11 vector interleaving broadcasting into the row3. The “Quad Weight/Vector Interleaving Broadcast” may indicate a 3D broadcast with a depth, where the depth may include a vector. The interleave may connect to 4 different weights (E00, E01, E10, E11) in Quad Pattern connection. The weights (E00, E01, E10, E11) may include, without limitation, four different vectors with size of eight elements (e.g. (1, 8)). The vector is not limited to (1, 8), where the vector may include different sizes.

FIG. 10B is an illustration of an exemplary Operation for Quad Elements Interleaving Broadcast with Accumulation of Vector (0 . . . 7), in accordance with an embodiment of the present invention. In an embodiment of the present invention, the E00 vector may elementwise multiply individually with F00, F02, . . . F06; E10 vector will do elementwise multiply individually with F10, F12, . . . F16; again E00 vector will do elementwise multiply individually with F20, F22, . . . F26; and E10 vector will do elementwise multiply individually with F30, F32, . . . F36; and E01 vector will do elementwise multiply individually with F01, F03, . . . F07; E11 vector will do elementwise multiply individually with F11, F13, . . . F17; E01 will do elementwise multiply individually with F21, F23, . . . F27; and E11 will do elementwise multiply individually with F31, F33, . . . F37. After the elementwise multiply is summation of the result of elementwise multiplication. Adder 148 may be used to sum up the result of elementwise multiplication. And accumulator 150 may be used to store the sum.

FIG. 10C is an illustration of an exemplary four (4) adder tree into Quad Pixels, in accordance with an embodiment of the present invention. In an embodiment of the present invention, each Pixel may represent a group of elements (e.g., vector). The results of the four adder trees 152 154 156 158 may be added together into an adder4 160 to get a result “SUM”. MUX 162 may be used to control which result to write to accumulator (ACC) 166. Accumulator 166 may include, without limitation, an adder 164 and an ACC 166 register. There are 5 items to select from, P0, P1, P2, P3 and “SUM”. Accumulator 164 and 166 may include multiple accumulators, for example, without limitation, at least four (4) accumulators. MUX 162 may be used to control which accumulator to write to. In this way, four (4) accumulators may be used in each operation. In FIG. 10C, computing units P0, P1, P2, and P3 are positioned at locations “0,” “1,” “2,” and “3,” with corresponding structures illustrated as 154, 152, 156, and 158, respectively. The results from these units are accumulated using adder4 (160) and stored in the accumulator (ACC 164). This design allows for at least four accumulator sets, or multiples thereof. Without the adder4 logic, accumulators could become fully occupied. In this Quad Pixel Scheme, we optimize accumulator usage, enhancing the system's capacity to handle greater weight or feature map stagnation.

FIG. 11A and FIG. 11B are illustrations of exemplary “FVC broadcast”, in accordance with an embodiment of the present invention. Referring to FIGS. 8A-8D, the feature vector context may be broadcasted and reflected in FIGS. 11A and 11B. Feature vector context may broadcast as “FVC broadcast” and the feature vector context may broadcast across many different three-dimensional computing structures. In one embodiment of the present invention, two-dimensional weights may be broadcast in the X direction 171 176 181 for each CUBE 170 175 180 of processing elements. Different methods of connecting weight vectors to feature vectors for multiply-accumulate (MAC) operations include, without limitation, QUAD connections. In another embodiment, three-dimensional weights may be broadcast in the X direction. For parallel computing CUBEs, multiple different weights may be broadcast in the X direction, adding an extra dimension. Taking all these factors into account, four-dimensional weights may be broadcast in the X direction.

In some embodiments, a three-dimensional feature map may broadcast across multiple CUBEs using, without limitation, a broadcast scheme or a pipeline scheme. Regardless of the method employed, the system demonstrates how tensors may be processed in a high-dimensional computing environment.

In FIG. 11B, two-dimensional accumulators 185 190 195 from each CUBE may be provided from the adder tree.

FIG. 11C is an illustration of exemplary accumulators 200, in accordance with an embodiment of the present invention. In one embodiment of the present invention, the accumulator is configured to accumulate multiple cycles from an adder tree. The accumulator may support various formats of Multiply and ADD (MAD) operations. The accumulator may store data in a format closely resembling floating point or integer formats such as INT26 or INT32. To optimize energy efficiency during storage and retrieval operations on SRAM and DRAM, a bit-width of the data may be reduced to INT8 or converted to floating-point formats like FP8, FP16 or BF16 for the input feature map of the subsequent layer.

Accumulators 200 may be reduced to a small bit-width. One method may use a max exponent associated with the same location of 4×8 tile. For example, without limitation, a set of 8 accumulators 200 is shown on the left (e.g. purple0, blue1, white2-6, green7). Then the 8-accumulator set is packed into a 3D chunk with size (y, x, z)=(4, 8, 8). At the same time, reduce the bit-width of the tensor. The max exponent part of the accumulators (P00ACC, P00ACC, . . . P00ACC) may be determined in Group Quantization block 205. The max exponent +1 of P00ACC is shared among the P00. The floating point represents 1.Mant*2\hat{ }(exponent-bias). The P00ACCs are shifted right a different amount depending on the max_exponent+1−cur_exponent. For example, a set of eight accumulator with value: (1.mant0*2\hat{ }exp0, 1.mant1*2\hat{ }exp1, 1.mant2*2\hat{ }exp2, . . . 1.mant7*2\hat{ }exp7), (note: 2\hat{ }exp means 2 to power of exp). Quantize into a value of 2\hat{ }max_exp*(1.mant0>>(max_exp+1−exp0), 1.mant1>>(max_exp+1−exp1), 1.mant2>>(max_exp+1−exp2), . . . , 1.mant7>>(max_exp+1−exp7)), (note: “>>” means shift right). Then, all the mantissa related may be quantized and represented as INT8. The total storage may be 1 byte for exponent and sign bit and 1 byte for each value. There are 8 elements in P00. Then a total 9 bytes to represent this. Represented as EXP.int8 format. Comparing with the FP16, reduce the total bytes from 16 bytes to 9 bytes. Apply the same technique to the other pixel in 4×8 tile. Then, finish the whole chunk with size of (4, 8, 8). The two chunk 2×(4, 8, 8) are packed as a bigger chunk with a size of (8, 8, 8). For a surface with a big size like 4096×4096, a tensor may be provided with a size of 4096×4096=(512×8)×(64×8×8)=512×64×(8, 8, 8). The blocks are packed together as a surface of 512×64×(8,8,8). The total size is 16M Bytes. Then the share exponent may be packed. Each super block (8, 8, 8) have shared exponents (8, 8) in each big block size (8, 8, 8). An exponent within 8 components may be shared in depth direction. Then, a shared exponent with a size of 512×64×(8, 8) of a surface with a size 4096×4096. Even component is a byte, and the total size is 2M Bytes. In total for a tensor, for two surfaces, one is a packed surface of a format “int8” and the other is a packed surface of a format “exponents”.

In some embodiment, block 205 may be quantized to INT4 with a shared exponent in block 210. Called EXP.int4 format. Then pack the “int4” in a surface and pack “exponent” in another surface. In an example of 4096×4096, the surface of “int4” is 8M Bytes. Each 16 elements of “int4”, shared an exponent, and each exponent is a byte. Then a surface of packed component with 1M Bytes.

In an alternative embodiment, block 215 performs quantization on the vector using Exponent and Scale. This involves finding the maximum exponent along the depth dimension and adjusting values to fit within the range (−1, 1). Here, the maximum value is scaled to 1 or the minimum to −1 along the depth direction. The exponent, combined with the reciprocal of the scaling factor, defines the scaling value for this group along the FVF broadcast direction. Each element in the group is divided by this scaled value and rounded to the target bit-width (e.g., 8, 4, or 2 bits). For storage, only the rounded values at the designated bit-width are saved. Groups can be of size 16, 32, or 64 elements, depending on bit-width, with each group represented by 16 Bytes. The entire group shares a single scaled value (comprised of the max exponent and the reciprocal of the “associated mantissa value with a hidden bit”). This is the quantization scheme. For de-quantization, the quantized value is multiplied by the shared scaling value to retrieve the original data scale.

A packing logic block 220 may be responsible for organizing the result into a standard size, such as a 512-byte chunk. For example, in the INT8 format, the tile size (8, 8, 8) yields 512 bytes, while in the INT4 format, the tile size (8, 8, 16) also results in 512 bytes. This scheme offers flexibility to select regular sizes, such as 512 bytes, 1024 bytes, or other desired sizes.

Quantization into INT8 may be performed on a per-tensor, per-channel, or per-group basis, where a scaling factor may be shared among respective granularity levels. Sharing the scaling factor at smaller levels increases accuracy, with the hierarchy being tensor>channel>group. Each granularity level requires additional storage for the scaling factor, which may be either a few bits, one or two bytes in size.

When values are quantized, the resulting Quantization Values may be in INT8 or INT4 format. The scaling factor may be shared across a subset of planes, exemplified by sharing among one out of four planes. To minimize the overhead associated with the scaling factor, values are grouped in larger sets, such as 8, 16, 32, or 64.

In another embodiment, the scaling factor may be reduced to a scaling exponent, limiting it to, without limitation, powers of 2. The approach further reduces energy consumption and storage requirements.

The quantized values may be packed into a CUBE configuration, preparing the quantized values for the next stage or layer of processing. The CUBE may be a 3D block representing part of a tensor. For a 2D tensor result, like a matrix, its columns may be folded into a 2D array by packing every 16 bytes along the z-direction. This forms a 3D tensor with row, column, and z-direction dimensions.

FIG. 11D is an illustration of a method for determining maximum exponents of different accumulators 230 235 from various CUBEs, in accordance with an embodiment of the present invention. In one embodiment, the maximum exponent is shared 240, and a right shift operation 245 is applied to the hidden bit and mantissa. For floating point, there is a hidden bit and mantissa part. The value is 1.mant (1+fraction) and multiply the 2 to power of (exponent-exponent bias). For example, floating point 1.0=0x3f80000. The format is 1 bit for sign, 8 bits for exponent and 23 bits for mantissa. Then the sign bit is zero. Exponent part is 0x7f and the exponent bias is 0x7f. Then the (exponent−exponent bias)=0, the 2 to power of 0 is 1. The 23 bits mantissa are all zero. However, there is a hidden bit. The hidden and mantissa represent 1.mant=1.0 now. To sum up, the 0x3f8000=1.0. The logic will find the max exp, then get the 1.mant for the fix point. Make the 1.mant to a total 7 bits fix point. The format will be like 1.xxxxxx. x represents either 0 or 1. Then multiply this to 64. That is 7 bits integer now: 1xxxxxx. After this, combine with the sign bit and these 7 bits and apply the two's complement. Get a value with INT8. Do the shift right of the other value according to the distance of exp_max with the exp value. Might get a smaller number and fill more zero in the significant bits. For example, if the distance of exp_mant with current exp is 2, then the 7 bits value will be 001xxxx. Then do the same thing to apply the sign bit and get INT8 value. The description above is to obtain the final UINT7 value 250. Subsequently, the sign bit and 2's complement method 255 is applied to derive the INT8 value 260.

In some embodiment, the method may be applied to numerous quantization schemes. The scaling factor may be shared within a group, where the group size may vary. For illustrative purposes, an example is provided with a group size of four elements 265.

Within a group of 4, compare the exponent value of these four, choose the max value in box 235. The diagram shows 4×8 groups. Combine the max_exp of these 4×8 groups in box 270.

FIG. 12A is an exemplary block level diagram of a DFPU architecture and data flow, in accordance with an embodiment of the present invention. In an embodiment of the present invention, Data Flow system 1200, features, not a limitation, three sets of loop registers: namely, “fLoop registers set 1205” for feature loops across multiple dimensions, the “wLoop registers set 1215” for weight loops across multiple dimensions, and “aLoop registers set 1210” for controlling ALU actions, encompassing action type, action direction, and result write-back. The loop registers play a pivotal role in coordinating various aspects of the system. “fLoop registers set 1205” may be associated with Feature stride registers 1220 to determine address strides for each count and dimension. The registers, in conjunction with Feature stride registers 1220, help specify the locations of features in multiple dimensions, across multiple cores, chips, or systems.

For weights, “wLoop registers set 1215” may serve as weight loop count registers for multiple dimensions. The set works in tandem with Weight stride registers 1225 to define locations within multiple addresses in a DFPU core. In the diagram, one of the cores is shown. The address could point to the other DFPU core(s) and fetch from or store to the other core, across different cores, chips, or systems.

“aLoop registers set 1210” may control ALU 1235 actions, including action type, action direction, and result write-back. The result write-back may be associated with Result stride registers 1230, specifying addresses across multiple dimensions.

Requests from “fLoop registers set 1205,” “wLoop registers set 1215,” and “aLoop registers set 1210” are sent to an arbitrator 1240. The arbitrator may determine whether to initiate read requests for feature maps or weights or write requests for results and may communicate the information to an Address Generation module 1245, which generates read and write addresses and sends control signals to the read/write action block 1250.

Read/write action block 1250 may manage the SRAM for reading or writing across different, various, and/or multiple memory banks. Address Generation 1245 may provide read and write addresses to memory subsystem 1280, which includes SRAM and HBM/DRAM 1255. Memory subsystem 1280 either sends Read Data or receives Write Data. The Read Data may be processed through the “Block level Decompress or Block Decompression Logic device 1260” to decompress into data, which is then stored in registers “Work group of Feature map 1267” or “Work group of Kernel Weight 1265”

The “aLoop” may control the type and direction of ALU actions. The ALU itself is a multi-dimensional adder tree group. In each action, temporal data may accumulate in the “Work group of ACC map 1270.” After several loops controlled by the “aLoop registers set,” the accumulated ACC result may be written back to “Block Level Compress or Block Compression Logic device 1275.” After compression, the data may be written to memory subsystem 1280. In some embodiments, compression and decompression are optional components in the system. In other embodiments, an Advanced Encryption Standard (AES) function may be incorporated for robust key management and providing enhanced security for the storage of weights. The function may ensure the protection of sensitive weight data and enhances the processor's high-dimensional computing capabilities, optimizing data retrieval, synchronization, execution, and storage processes while maintaining data security. For example, the Advanced Encryption Standard (AES) is an algorithm that uses the same key to encrypt and decrypt protected data, such as weight data. Instead of a single round of encryption, data is put through several rounds of substitution, transposition, and mixing to make it harder to compromise.

Additionally, “fLoop registers set 1205,” “wLoop registers set 1215,” and “aLoop registers set 1210” may be renamed or combined into larger register sets or separated into smaller ones while still staying within the scope of the invention. The simplified example is provided for a better understanding of the invention, but the actual system is expected to be much more complex than the description presented here.

FIG. 12B is an illustration of an exemplary flowchart of a Data Flow system process, in accordance with an embodiment of the present invention. In one embodiment of the present invention, In a Step 1251, Fetch instruction goes to Decode and Fill fLoop, wLoop, aLoop, Feature Stride, weight Stride and Result Stride in a Step 1252. Then goes to Steps 1261, 1262 and 1263. In Step 1261, fLoop, keep multiple dimensional loop until fLoop is done. In Step 1262, wLoop, keep multiple dimensional loop until wLoop is done. In Step 1263, aLoop, keep multiple dimensional loop until aLoop is done. Between Steps 1261, 1262 and 1263, these three blocks will sync for the operation. Then Steps 1261 to 1271, 1262 to 1272, 1263 to 1273. In Steps 1271-1273, check logic checks whether it is done or not. If it is done, it will go to the end (Task is done in a Step 1290). If it is not done, in Steps 1276, 1277, 1278, the address may be calculated based on the corresponding stride register. Feature, Weight and Result may use the same calculation formula. Then in Steps 1276 to 1281, 1277 to 1282, 1278 to 1287. In Steps 1281 and 1282, for the feature and weights, a chunk of data may be fetched and stored in feature and weight registers, and then start to process according to an Op code in a Step 1286. The operation could be multiply, adder or adder tree operations etc. And then the temporary partial result may be stored in accumulators. When the accumulation is done, the result may be written out in a Step 1287.

FIG. 13A and FIG. 13B are illustrations of an overview of a System-on-Chip (SOC) 1300, in accordance with some embodiment of the present invention. System-on-Chip (SOC) 1300 features a configuration with, not a limitation, 16 cores 1305 where a single core 1305 boasts a staggering 9,216 Accumulators, making it a colossal core, far beyond the capabilities of a mere individual accumulator. Cores 1305 are grouped into quadcore sets 1310, with each quadcore set 1310 interconnected via a bi-directional ring 1315. The quad cores themselves are connected through a Mesh network, utilizing a 256-byte bus 1320, the width of which may be adjusted based on specific requirements. FIG. 13A and FIG. 13B are identical except for the configuration of the 256-byte bus 1320. FIG. 13A shows a winding 256-byte bus 1317 while FIG. 13B shows a straight 256-byte bus 1317. Cores 1305 may include, not a limitation, DFPUs 315. The traditional NOC for DFPU (data flow processor unit) may be leveraged. Or use proprietary NOC for mode Swap data, Broadcast and Fetch data.

The SOC may incorporate a comprehensive array of peripheral interfaces and functions to support its intricate operations. The interfaces and functions may be designed to share nodes within the Mesh networks. They may include, not a limitation:
UCIE (Universal Chiplet Interconnect Express) 1315: An open specification for die-to-die interconnect and serial bus communication between chiplets.
PCIe (Peripheral Component Interconnect Express) 1320: A high-speed interface standard for connecting various input and output components.
MIPI CSI (Camera Serial Interface): An interface architecture defining protocols for communication between embedded cameras and host processors.
BT656 (8-bit interface with syncs) and ITU1120 (16-bit interface with syncs) for streaming uncompressed PAL or NTSC standard-definition TV.
ISP (Image Signal Processor): Used for processing images in embedded vision camera systems.
GIGA ETH (Gigabit Ethernet): A transmission technology based on Ethernet frame format and protocol used in local area networks.
DDR (Double Data Rate): An advanced version of synchronous dynamic random-access memory.
HBM (High Bandwidth Memory): A standardized stacked memory technology providing wide channels for data transfer.
FIPS (Federal Information Processing Standard) 140-3: A benchmark for validating the effectiveness of cryptographic hardware.
Optical Com: Systems for transmitting information optically through fibers.
I2C/I2S Audio: Communication interfaces for inter-IC data transfer and audio transport.
DMA (Direct Memory Access): A data transfer process without direct processor involvement.
GPIO (General-Purpose Input/Output): Digital signal pins on integrated circuits or electronic boards, controllable by software.
PWM (Pulse Width Modulation): A control technique for generating analog signals from digital devices.
UART (Universal Asynchronous Receiver/Transmitter): A communication protocol circuit for serial data transfer.
SPI (Serial Peripheral Interface): A common interface for short-distance communication between microcontrollers and peripheral integrated circuits.
H.265 and H.264: Common video streaming methods used by services like YouTube and Netflix.
MJPEG (Motion JPEG): A format for individually compressed pictures.
Cortex Quad Core CA57: ARM's Cortex-A57 processor with four cores.

It's important to note that the SOC is a versatile example, and different functions or processors may be combined within it to suit specific applications and requirements.

In one embodiment, Data Flow Processor Unit (DFPU) 315 and System-on-Chip (SoC) 1300 have a close relationship within a computing system. The DFPU serves as a specialized hardware component designed to efficiently perform data processing tasks, particularly suited for AI and machine learning workloads discussed previously. On the other hand, the SoC is a comprehensive integrated circuit that incorporates various hardware components, including processors, memory units, input/output interfaces, and often specialized accelerators like the DFPU.

The relationship between the DFPU and SoC can be described as follows:
Integration: The DFPU is integrated into the larger architecture of the SoC. It operates alongside other components within the SoC, sharing resources and interacting with the system as a whole.
Acceleration: The DFPU functions as an accelerator within the SoC, enhancing the performance and efficiency of specific computing tasks, particularly those related to data-intensive operations like deep learning inference and neural network computations.
Optimization: The DFPU is optimized to work in conjunction with other components of the SoC, leveraging shared resources and communication pathways to maximize overall system performance.
Interface: The DFPU typically interfaces with other components of the SoC through standardized interfaces and protocols, enabling seamless communication and data exchange within the system.
Customization: Depending on the specific application requirements, the DFPU may be customized or configured within the SoC to meet the needs of the targeted workload, ensuring optimal performance and efficiency.

Overall, the DFPU and SoC collaborate closely to deliver efficient and high-performance computing capabilities, particularly in the realm of AI and machine learning applications, where data processing efficiency is paramount.

FIG. 14 is an illustration of a larger-scale system (than the system shown in FIG. 13), with 64 high-dimensional cores interconnected via a Mesh network boasting a 256-byte bus width, in accordance with some embodiment of the present invention. The configuration is highly adaptable and not constrained by the number of cores, making the invention suitable for a wide range of combinations.

In a larger system, where multiple DFPU cores 1305 are integrated into the System-on-Chip (SoC), several considerations arise to ensure optimal performance and functionality:
Memory Channels: With increased computational demands from multiple DFPU cores, additional memory channels become essential to provide sufficient memory bandwidth. This may involve integrating multiple DRAM controllers or increasing the capacity and speed of High Bandwidth Memory (HBM) or DDR memory interfaces within the SoC.
Peripheral Interfaces: To support expanded functionality and connectivity, the SoC may incorporate more channels of camera interfaces, such as MIPI (Mobile Industry Processor Interface) and ISP (Image Signal Processor) interfaces. This allows for the simultaneous processing of data from multiple cameras or sensors, enabling advanced imaging and computer vision applications.
Scalability: The SoC architecture should be designed with scalability in mind, allowing for easy integration of additional DFPU cores, memory channels, and peripheral interfaces as computational requirements grow. This ensures flexibility and adaptability to future system upgrades and enhancements.
System Integration: Proper system integration is crucial to ensure seamless communication and coordination among various components, including, not a limitation, DFPU cores, memory interfaces, and peripheral interfaces. This involves efficient routing of data and control signals, as well as synchronization mechanisms to enable synchronized operation of multiple cores and peripherals.
Power and Thermal Management: As the number of DFPU cores 1305 and peripheral interfaces increases, power consumption and thermal dissipation become significant concerns. The SoC design should incorporate advanced power management techniques and thermal mitigation strategies to optimize energy efficiency and maintain thermal stability under varying workloads.

By addressing these considerations, the larger system can effectively harness the computational power of multiple DFPU cores while supporting expanded memory bandwidth, connectivity options, and scalability for diverse application requirements.

FIG. 15 illustrates an exemplary seamless integration 1500 of 6 DFPU processors 1505A-1505F through UCIE interfaces 1510, in accordance with an embodiment of the present invention. To optimize the configuration, 6 DFPU processors 1505n are organized into a 3×2 array. The connectivity between the DFPU processors 1505n may be established through two UCIE channels 1510, providing a total of 6 channels per chip 1505n. The arrangement may include, not a limitation, two connections for the top, two for the left or right, and two for the bottom, ensuring robust inter-chip communication. Furthermore, each chip 1505n may be equipped with two interfaces 1515, allowing for efficient connections to HBM 1520. In aggregate, there are 12 HBM channels 1515 available for the configuration of 6 chips 1505n. All the connections, both UCIE 1510 and HBM 1515, are facilitated through a Silicon interposer 1525, ensuring seamless integration and data exchange among DFPU processors 1505n. The innovation 1500 enables a versatile range of connection channels and accommodates any number of chip connections. The example presented is merely a straightforward illustration, and the scope of the invention extends beyond the above limitations.

FIG. 13 illustrates a small System-on-Chip (SoC) system, while FIG. 14 depicts a larger SoC system. Both of these systems can leverage packaging technologies such as Chip-on-Wafer-on-Substrate (COWOS) to integrate into a larger chip, as described previously. COWOS enables the integration of multiple chips or components into a single, larger chip package, facilitating enhanced performance, compactness, and efficiency. FIG. 15 demonstrates the integration of these SoC chips into an even larger chip, enabling support for more extensive tasks and applications. This integration allows for the aggregation of computational resources, memory bandwidth, and peripheral interfaces, enabling the system to handle more significant workloads and deliver enhanced functionality.

Overall, the use of packaging technologies like COWOS and the integration of SoC chips into larger chips enable scalability, performance optimization, and enhanced capabilities for a wide range of applications, from small embedded systems to large-scale computing platforms.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

FIG. 16 illustrates a block diagram depicting a conventional client/server communication system, which may be used by an exemplary web-enabled/networked embodiment of the present invention.

A communication system 1600 includes a multiplicity of networked regions with a sampling of regions denoted as a network region 1602 and a network region 1604, a global network 1606 and a multiplicity of servers with a sampling of servers denoted as a server device 1608 and a server device 1610.

Network region 1602 and network region 1604 may operate to represent a network contained within a geographical area or region. Non-limiting examples of representations for the geographical areas for the networked regions may include postal zip codes, telephone area codes, states, counties, cities and countries. Elements within network region 1602 and 1604 may operate to communicate with external elements within other networked regions or within elements contained within the same network region.

In some implementations, global network 1606 may operate as the Internet. It will be understood by those skilled in the art that communication system 1600 may take many different forms. Non-limiting examples of forms for communication system 1600 include local area networks (LANs), wide area networks (WANs), wired telephone networks, cellular telephone networks or any other network supporting data communication between respective entities via hardwired or wireless communication networks. Global network 1606 may operate to transfer information between the various networked elements.

Server device 1608 and server device 1610 may operate to execute software instructions, store information, support database operations and communicate with other networked elements. Non-limiting examples of software and scripting languages which may be executed on server device 1608 and server device 1610 include C, C++, C #and Java.

Network region 1602 may operate to communicate bi-directionally with global network 1606 via a communication channel 1612. Network region 1604 may operate to communicate bi-directionally with global network 1606 via a communication channel 1616. Server device 1608 may operate to communicate bi-directionally with global network 1606 via a communication channel 1614. Server device 1610 may operate to communicate bi-directionally with global network 1606 via a communication channel 1618. Network region 1602 and 1604, global network 1606 and server devices 1608 and 1610 may operate to communicate with each other and with every other networked device located within communication system 1600.

Server device 1608 includes a networking device 1620 and a server 1622. Networking device 1620 may operate to communicate bi-directionally with global network 1606 via communication channel 1616 and with server 1622 via a communication channel 1624. Server 1622 may operate to execute software instructions and store information.

Network region 1602 includes a multiplicity of clients with a sampling denoted as a client 1626 and a client 1628. Client 1626 includes a networking device 1634, a processor 1636, a GUI 1638 and an interface device 1640. Non-limiting examples of devices for GUI 1638 include monitors, televisions, cellular telephones, smartphones and PDAs (Personal Digital Assistants). Non-limiting examples of interface device 1640 include pointing device, mouse, trackball, scanner and printer. Networking device 1634 may communicate bi-directionally with global network 1606 via communication channel 1612 and with processor 1636 via a communication channel 1642. GUI 1638 may receive information from processor 1636 via a communication channel 1644 for presentation to a user for viewing. Interface device 1640 may operate to send control information to processor 1636 and to receive information from processor 1636 via a communication channel 1646. Network region 1604 includes a multiplicity of clients with a sampling denoted as a client 1630 and a client 1632. Client 1630 includes a networking device 1648, a processor 1650, a GUI 1652 and an interface device 1654. Non-limiting examples of devices for GUI 1638 include monitors, televisions, cellular telephones, smartphones and PDAs (Personal Digital Assistants). Non-limiting examples of interface device 1640 include pointing devices, mousse, trackballs, scanners and printers. Networking device 1648 may communicate bi-directionally with global network 1606 via communication channel 1616 and with processor 1650 via a communication channel 1656. GUI 1652 may receive information from processor 1650 via a communication channel 1658 for presentation to a user for viewing. Interface device 1654 may operate to send control information to processor 1650 and to receive information from processor 1650 via a communication channel 1660.

For example, consider the case where a user interfacing with client 1626 may want to execute a networked application. A user may enter the IP (Internet Protocol) address for the networked application using interface device 1640. The IP address information may be communicated to processor 1636 via communication channel 1646. Processor 1636 may then communicate the IP address information to networking device 1634 via communication channel 1642. Networking device 1634 may then communicate the IP address information to global network 1606 via communication channel 1612. Global network 1606 may then communicate the IP address information to networking device 1620 of server device 1608 via communication channel 1616. Networking device 1620 may then communicate the IP address information to server 1622 via communication channel 1624. Server 1622 may receive the IP address information and after processing the IP address information may communicate return information to networking device 1620 via communication channel 1624. Networking device 1620 may communicate the return information to global network 1606 via communication channel 1616. Global network 1606 may communicate the return information to networking device 1634 via communication channel 1612. Networking device 1634 may communicate the return information to processor 1636 via communication channel 1642. Processor 16166 may communicate the return information to GUI 16168 via communication channel 1644. User may then view the return information on GUI 1638.

FIG. 17 is a block diagram depicting an exemplary client/server system which may be used by an exemplary web-enabled/networked embodiment of the present invention.

A communication system 1700 includes a multiplicity of clients with a sampling of clients denoted as a client 1702 and a client 1704, a multiplicity of local networks with a sampling of networks denoted as a local network 1706 and a local network 1708, a global network 1710 and a multiplicity of servers with a sampling of servers denoted as a server 1712 and a server 1714.

Client 1702 may communicate bi-directionally with local network 1706 via a communication channel 1716. Client 1704 may communicate bi-directionally with local network 1708 via a communication channel 1718. Local network 1706 may communicate bi-directionally with global network 1710 via a communication channel 1720. Local network 1708 may communicate bi-directionally with global network 1710 via a communication channel 1722. Global network 1710 may communicate bi-directionally with server 1712 and server 1714 via a communication channel 1724. Server 1712 and server 1714 may communicate bi-directionally with each other via communication channel 1724. Furthermore, clients 1702, 1704, local networks 1706, 1708, global network 1710 and servers 1712, 1714 may each communicate bi-directionally with each other.

In one embodiment, global network 1710 may operate as the Internet. It will be understood by those skilled in the art that communication system 1700 may take many different forms. Non-limiting examples of forms for communication system 1700 include local area networks (LANs), wide area networks (WANs), wired telephone networks, wireless networks, or any other network supporting data communication between respective entities.

Clients 1702 and 1704 may take many different forms. Non-limiting examples of clients 1702 and 1704 include personal computers, personal digital assistants (PDAs), cellular phones and smartphones.

Client 1702 includes a CPU 1726, a pointing device 1728, a keyboard 1730, a microphone 1732, a printer 1734, a memory 1736, a mass memory storage 1738, a GUI 1740, a video camera 1742, an input/output interface 1744 and a network interface 1746.

CPU 1726, pointing device 1728, keyboard 1730, microphone 1732, printer 1734, memory 1736, mass memory storage 1738, GUI 1740, video camera 1742, input/output interface 1744 and network interface 1746 may communicate in a unidirectional manner or a bi-directional manner with each other via a communication channel 1748. Communication channel 1748 may be configured as a single communication channel or a multiplicity of communication channels.

CPU 1726 may be comprised of a single processor or multiple processors. CPU 1726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1736 is used typically to transfer data and instructions to CPU 1726 in a bi-directional manner. Memory 1736, as discussed previously, may include any suitable computer-readable media, intended for data storage, such as those described above excluding any wired or wireless transmissions unless specifically noted. Mass memory storage 1738 may also be coupled bi-directionally to CPU 1726 and provides additional data storage capacity and may include any of the computer-readable media described above. Mass memory storage 1738 may be used to store programs, data and the like and is typically a secondary storage medium such as a hard disk. It will be appreciated that the information retained within mass memory storage 1738, may, in appropriate cases, be incorporated in standard fashion as part of memory 1736 as virtual memory.

CPU 1726 may be coupled to GUI 1740. GUI 1740 enables a user to view the operation of computer operating systems and software. CPU 1726 may be coupled to pointing device 1728. Non-limiting examples of pointing device 1728 include computer mouse, trackball and touchpad. Pointing device 1728 enables a user with the capability to maneuver a computer cursor about the viewing area of GUI 1740 and select areas or features in the viewing area of GUI 1740. CPU 1726 may be coupled to keyboard 1730. Keyboard 1730 enables a user with the capability to input alphanumeric textual information to CPU 1726. CPU 1726 may be coupled to microphone 1732. Microphone 1732 enables audio produced by a user to be recorded, processed and communicated by CPU 1726. CPU 1726 may be connected to printer 1734. Printer 1734 enables a user with the capability to print information to a sheet of paper. CPU 1726 may be connected to video camera 1742. Video camera 1742 enables video produced or captured by user to be recorded, processed and communicated by CPU 1726.

CPU 1726 may also be coupled to input/output interface 1744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1726 optionally may be coupled to network interface 1746 which enables communication with an external device such as a database or a computer or telecommunications or internet network using an external connection shown generally as communication channel 1717, which may be implemented as a hardwired or wireless communications link using suitable conventional technologies. With such a connection, CPU 1726 might receive information from the network, or might output information to a network in the course of performing the method steps described in the teachings of the present invention.

FIG. 18 illustrates an exemplary system modules architecture diagram for distributing weight tensor data and feature map data, in accordance with an embodiment of the present invention. System 2000 may include, without limitation, memory module DRAM 2010 and DFPU module 2020. The DFPU module system architecture and data flow may be implemented in accordance with the embodiments shown and described in connection with FIGS. 12A and 12B. DRAM 2010 may include, without limitation, an external memory bank for holding weight models. Within DFPU module 2020, comprises a data transfer module DMA 2030 for handling data transfer(s) between DRAM 2010 and memory bank SRAM 2050. The DMA may allow direct data movement between the memory modules and peripherals without involving the CPU, speeding up data transfer and reducing CPU load. DMA 2030 may transfer data from external memory sources like DRAM 2010 or peripherals to the system's internal memory module Static Random-Access Memory (SRAM) 2050. SRAM is typically faster but smaller than DRAM, that is generally used for quicker access to critical data during system operations. Referring to FIG. 1 and FIG. 18, DRAM 2010 and SRAM 2050 is similar to the multiple bank memory 105. The DMA module is controlled by a High Dimensional Loop Control module 2040 to control the loop between memory modules DRAM 2010 and SRAM 2050. The purpose is to control weight or feature map stagnation exemplified in FIGS. 5A and 5B. When the feature map is stagnant, the feature map may be reused, but weights may be discarded when the feature map is used. When the weights are stagnant, the weights may be reused, but the feature map may be discarded when the weights are used. A weight stagnant module may include a weight buffer (KBUF) 2070 and a feature map stagnant module may include, without limitation, a feature map buffer (FBUF) 2060. KBUF 2070 is a small buffer for keeping a copy of kernel weights fetched from multiple memory bank SRAM 2050. A weight selector 2072 may select a portion of weights from KBUF 2070 and output to a weight broadcast (QKX) buffer 2075. QKX buffer 2075 may distribute the portion of weights to an arithmetic logic unit (ALU) 2080 having, without limitation, high dimensional computing Tensor cores 2081, 2083, 2085 and 2087. QKX buffer 2075 may broadcast individual weight into the different tensor cores according to different mode describe in FIG. 6, FIG. 7, FIG. 8 to FIG. 11. QKX buffer 2075 may hold multiple input and output channels of weights. QKX buffer 2075 may perform single weight, dual weight and/or quad weight broadcast describe in FIG. 6 to FIG. 11. FBUF 2060 is a small buffer configured to hold a small copy of feature map. A feature map selector 2062 may choose a feature map chunk and output to FVC Buffer 2065 and broadcast into high dimensional computing tensor cores 2081, 2083, 2085 and 2087. Referring to FIG. 2 (160), an elementwise multiplication operation of the feature map vector is shown with the broadcast weight vector together, then summation of these result together in FIG. 2 (157) and put the result in accumulator FIG. 2 (150). In the computing tensor cores, we have the number of 4×8 of these structure 160. Then we can do a lot of computing every cycle. The feature map broadcast is described in FIG. 1 (130). Selector 2072 of KBUF and selector 2062 of FBUF may trigger the simultaneous selection of weights and feature map. Selectors 2072 and 2062 may comprise, without limitations, multiplexers, multiway switch, etc. Selectors 2072 may enable precise control over which portion of a weight chunk the system needs to fetch during each computing cycle. The KBUF buffer holds multiple weight chunks, allowing Selectors 2072 to select specific portions of the weights for processing on a per-cycle basis. The mechanism facilitates a process called weight stagnation: by continuously fetching different portions of the weights and multiplying them with feature maps chosen by Selector 2062. The system efficiently processes each set of feature maps.

Once a round of weight-fetching completes, the system may reuse the weight chunks by fetching a different segment of weights and combining it with a new set of feature maps. The cyclical use of weight chunks and feature maps optimizes computation by avoiding redundant memory accesses and enhancing parallelism.

In contrast, is feature stagnation. Here, selected feature map segments are reused over multiple cycles, allowing the map segments to combine with different weight portions fetched by Selectors 2072. The approach provides further efficiency, ensuring minimal memory bandwidth requirements and enabling dynamic adaptability in computations. Through the combination of weight and feature stagnation, the system achieves high computational efficiency and flexibility across varied workloads.

Selectors 2072 and 2062 are controlled by a High Dimensional Loop Control module 2040. The weight and feature map stagnant process may be implemented in KBUF 2070 and FBUF 2060. In some embodiment, KBUF 2070, FBUF 2060, QKX buffer 2075, FBUF 2060 and FVC Buffer 2065 may comprise without limitation, SRAM, DRAM, MRAM, Flash memory and/or RRAM. High Dimensional Loop Control module 2040 may control Tensor cores Loop module 2090. Tensor cores Loop module 2090 may control high level data moving in the high dimensional computing tensor cores including, without limitation, shift, rotate and pipeline. In each operation of high dimensional computing tensor cores, yields temporary results and stored in Accumulators 2082, 2084, 2086 and 2088. After the accumulators get the final value, the data may be packed. In FIG. 2, a 4×8 structure (160) is depicted, comprising an elementwise multiplier and adder tree for computing and accumulation, which serves as our basic computing unit. In FIG. 18, four of these structures—labeled 2081, 2083, 2085, and 2087, as illustrated in FIG. 2 (160)—are shown. The results of computations are stored in accumulators 2082, 2084, 2086, and 2088, with each high-dimensional ALU (2081, 2083, 2085, 2087) equipped with at least 4×8 accumulators.

Once accumulation completes, transitioning from partial summation to full summation, the system begins harvesting the results from the accumulators. By combining the four sets (2082, 2084, 2086, 2088) of 4×8 accumulators, we obtain a small chunk result of 4×8×4. This serves as our packing scheme, though the design is not limited to this specific size. Furthermore, this configuration allows for multiple accumulators within each adder tree, enabling a more flexible packing scheme and the potential to harvest larger chunks of data through Packing Logic & Write Back module 2089. Then the result may be written back into SRAM 2050. Furthermore, the data may either be kept in SRAM 2050 or written back to DRAM 2010 through the DMA module.

FIG. 19 illustrates exemplary software and system modules operable for software control and data flow, in accordance with an embodiment of the present invention. Software control and data flow module 2100 may include, without limitation, External Host and GPU application processor module 2105, External Memory module 2170 and NPU module 2180. External Host and GPU application processor 2105 handles many tasks including, without limitation, storage and retrieval of proprietary Model or Open Source Model 2110, Retraining, Refining, Pruning or Quantization Aware Training 2120, Post Quantization 2125, handling storage or retrieval of Quantized Model or Mixed Quantized Model 2130, Application for handling single or multiple models 2140, handling and managing multiple Input data 2142, handling and managing or post processing multiple Results 2145, Real Time or Offline Compiler 2150 or process Software libraries, Model Graph and Driver 2160. External Host module may prepare the initial memory allocation for External Memory module 2170. External Memory module 2170 may store different data or buffers including, without limitation, Command Stream and Model data (weights) 2171, Current Input data 2173, Intermediate Walking Buffer 2175 to hold intermediate hidden layer that outflow from NPU, KV Cache or other Cache 2177 and Current Results 2175. NPU module 2180 may include, without limitation, DMA Controller 2181, High Dimensional Loop Control 2183, Internal Memory and Buffers 2185 and DFPU 2187.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112(1), all claims must be supported by sufficient disclosure in the present patent specification, and any material known to those skilled in the art need not be explicitly disclosed. However, 35 USC § 112(6) requires that structures corresponding to functional limitations interpreted under 35 USC § 112(6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112 (f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve the right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing high-dimensional computing architectures according to the present invention will be apparent to those skilled in the art. Various aspects of the invention have been described above by way of illustration, and the specific embodiments disclosed are not intended to limit the invention to the particular forms disclosed. The particular implementation of the high-dimensional computing architectures may vary depending upon the particular context or application. By way of example, and not limitation, the high-dimensional computing architectures described in the foregoing were principally directed to the manipulation of 4-dimensional tensors in high-performance computing environments implementations; however, similar techniques may instead be applied to artificial intelligence, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72 (b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A high dimensional computing system, the system comprising:
a multiple bank memory, said multiple bank memory is configured to store weight tensor data and feature map data;
a weight tensor buffer, wherein said weight tensor buffer being configured to be operable for storing at least a portion of weight tensor data fetched from said multiple bank memory;
one or more broadcast buffers, said one or more broadcast buffer is configured to be operable for broadcasting said portion of weight tensor data from said weight tensor buffer to one or more computing units;
a feature vector context (FVC) buffer device, wherein said FVC buffer device being configured to store feature map chunk data fetched from said multiple bank memory;
wherein said FVC buffer device is further configured to transfer said feature map tensor chunks data to said one or more computing units;
one or more computing units, wherein said one or more computing units are configured to perform computing operations on the portion of weight tensor data fetched from said bank memory and the feature map data;
wherein said feature map data comprises at least one of a hidden layer that was generated after a layer was calculated; and
an accumulator implements, said accumulator implement is configured to be operable for storing at least one resultant value of a summation of an elementwise-multiplication operation of said weight tensor data and feature map data.

2. The system of claim 1, further comprising a multiplier implement, said multiplier implement being configured to be operable for carrying out said elementwise multiplication operation of said weight tensor data and feature map data.

3. The system of claim 2, further comprising an adder implement, wherein said adder implement is configured to be operable for summing said resultant value of the elementwise multiplication operation of said weight tensor data and feature map data.

4. The system of claim 3, wherein each of said one or more broadcast buffers comprise multiple output channels of one or many chunks of weight tensor data.

5. The system of claim 1, wherein said weight tensor data comprises trainable parameters of a training model in quad pixel format.

6. The system of claim 1, wherein said multiple bank memory comprise at least one of, an SRAM, an MRAM, a DRAM, a Flash memory and RRAM.

7. The system of claim 6, wherein said SRAM is used to hold a portion or block of weight tensor data in a stagnant state, looping and fetching a portion or block of the feature map to perform multiplication operations.

8. The system of claim 7, wherein said SRAM is used to hold a portion or block of the feature map in a stagnant state, looping and fetching a portion or block of weight tensor data to perform multiplication operations.

9. The system of claim 1, wherein each of said one or more computing units comprise at least one of a 3-dimensional computing cell and 4-dimensional computing cell.

10. The system of claim 1, wherein the weight tensor data is transferred to said one or more computing units by broadcasting and the feature map data is transferred to said one or more computing units by pipeline.

11. The system of claim 1, wherein the weight tensor data and feature map data are transferred to the one or more computing units through broadcasting along a selected dimension of a three-dimensional space, with the weight tensor data broadcast along a different dimension.

12. A method for processing tensor data comprising the steps of:
receiving tensor data with buffer memory, wherein said tensor data comprises a plurality of pixels, said plurality of pixels forms a vector;
grouping said plurality of pixels into sets of four adjacent pixels as Quad Pixels with one or more computing units;
calculating a representative value of each Quad Pixels with an adder tree, said representative value derived from the values of the four individual adjacent pixels;
storing the representative value into an accumulator of said adder tree.

13. The method of claim 12, wherein said calculating step comprises adding together a resultant value of an elementwise multiplication operation of said tensor data to get a summation of quad pixel results.

14. The method of claim 12, further comprising the step of applying a mux to select a final accumulation result from one of quad adder trees or the summation of all four quad adder trees.

15. The method of claim 12, further comprising the step of:
accumulating a final value; and
applying a quantization to the final value.

16. The method of claim 15, wherein said quantization step comprises finding a max value of an exponent.

17. The method of claim 16, further comprising the step of applying packing to form a chunk after said quantization step is performed.

18. The method of claim 12, wherein the step of transferring the portion of said feature map data further comprise pipelining said feature map data to said one or more computing units.

19. The method of claim 12, wherein the step of broadcasting the portion of said weight tensor data comprises single weight/vector broadcasting, wherein a single vector is broadcasted.

20. The method of claim 12, wherein the step of broadcasting the portion of said weight tensor data comprises double weight/vector interleaved broadcasting, wherein two vectors are broadcasted.

21. The method of claim 12, wherein the step of broadcasting the portion of said weight tensor data comprises Quad Weight Interleaving Broadcast, wherein four vectors are interleaved with four rows and broadcasted.

22. The method of claim 12, wherein said broadcasting step comprises single element broadcasting, wherein said single element broadcasting comprises vector broadcasting of partial or transposed matrix.

23. The method of claim 12, wherein said broadcasting step comprises a Quad Weight/Vector Interleaving Broadcast, wherein the interleave connects to at least four (4) different weights in Quad Pattern connection and the weights include at least four (4) different vectors.

24. The method of claim 22, wherein said elementwise multiplication, summing and storing steps comprises utilizing at least four adder trees.

25. A system for processing tensor data comprising:
an NPU that is configured to broadcast a portion of weight tensor data and a portion of feature map data simultaneously within a single cycle, said NPU comprises;
a first SRAM, said first SRAM is configured to hold said portion or block of weights in a stagnant state, looping and fetching a portion or block of the feature map to perform multiplication operations;
a second SRAM, said second SRAM is configured to hold a portion or block of the feature map in a stagnant state, looping and fetching a portion or block of weights to perform multiplication operations;
an adder tree that is operable for summing along one dimension; and
an accumulator that is configured to store partial sums.

26. The system of claim 25, wherein the weight tensor data is broadcasted along one of three-dimensional directions.

27. The system of claim 26, wherein the feature map data is broadcasted along one of said three-dimensional directions.

28. The system of claim 25, wherein said adder tree is used to sum along one dimension of three-dimensional or higher-dimensional computing cells.

29. The system of claim 25, wherein said adder tree is further operable for performing summation along with input channels or rows/cols.

30. The system of claim 25, wherein said NPU is further configured to perform a dynamic quantization of a group.

31. The system of claim 25, wherein said NPU is further configured to perform packing to form a high dimensional feature for a next processing unit or next layer.

32. The system of claim 25, wherein said NPU is further configured to perform a group of quantization, finding the maximum exponent value and apply quantization with the group.

33. An executable computer program product stored in a non-transitory computer-readable storage medium, wherein the computer program product instructs one or more processors to perform a method for processing tensor data comprising the steps of:
receiving weight tensor data from a memory bank;
storing said weight tensor data in a weight tensor buffer;
receiving feature map data from said memory bank;
storing said feature map data in a feature vector context (FVC) buffer which hold one or many chunks of feature tensor context;
broadcasting with one or more broadcast buffers, a portion of said weight tensor data;
receiving and processing said portion of weight tensor data with one or more computing units;
transferring a portion of said feature map data stored in said FVC buffer, to said one or more computing units;
receiving and processing said portion of feature map data in said one or more computing units;
performing elementwise multiplication operation of said weight tensor data and feature map data with a multiplier implement of an adder tree;
summing a result of the elementwise multiplication operation of said weight tensor data and feature map data with an adder implement of said adder tree; and
storing a result of the summation in an accumulator of said adder tree.

34. A system comprising:
a Data Flow Processor Unit (DFPU) module, said DFPU module is configured to be operable for distributing or broadcasting weight and feature map data;
a Data Flow system Module;
a weight stagnation system module, said weight stagnation system module is configured to control weight data loop(s) between external memory (DRAM) and internal memory (SRAM);
a feature map stagnation system module, said feature map stagnation system module is configured to control feature map data loop(s) between said external memory (DRAM) and internal memory (SRAM); and
a weights and feature map data distribution and broadcast system module being configured to be operable for broadcasting weight data and feature map data at least in part based upon inputs received from external memory to high dimensional computing tensor cores and to high dimensional computing tensor.

35. The system module of claim 34, wherein said DFPU and a System-on-Chip (SoC) have a close relationship within a computing system, and wherein said DFPU is a specialized hardware component that is configured to efficiently perform data processing tasks including AI and machine learning workloads.

36. The system module of claim 35, wherein said SoC comprises a comprehensive integrated circuit that incorporates at least one of processors, memory units, input/output interfaces, and specialized accelerators like the DFPU.

37. The system module of claim 36, wherein said DFPU is configured to operate alongside other components within the SoC, sharing resources and interacting with the system as a whole.

38. The system module of claim 37, wherein said DFPU enhances the performance and efficiency of data-intensive operations like deep learning inference and neural network computations.

39. The system module of claim 38, wherein said DFPU is optimized to work in conjunction with other components of the SoC, leveraging shared resources and communication pathways to maximize overall system performance.

40. The system module of claim 39, wherein said DFPU interfaces with other components of said SoC through standardized interfaces and protocols, enabling seamless communication and data exchange within the system.

41. The system module of claim 34, wherein when the feature map data is stagnant, the feature map data is reused and weight data is discarded when the feature map data is used.

42. The system module of claim 41, wherein when the weight data is stagnant, the weight data is reused and the feature map data is discarded when weight data is used.
